(19) United States
(12) Patent Application Publication
(10) Pub. No.: US 2018/0063105 A1
(43) Pub. Date: Mar. 1, 2018

(54) MANAGEMENT OF ENCIPHERED DATA SHARING

(71) Applicant: AtCipher.com Limited, Hong Kong (HK)

(72) Inventors: Jack S. Poon, Hong Kong (HK); Duncan S. Wong, Hong Kong (HK)

(21) Appl. No.: 15/691,423

(22) Filed: Aug. 30, 2017

Related U.S. Application Data
(60) Provisional application No. 62/382,289, filed on Sep. 1, 2016.
(60) Provisional application No. 62/382,300, filed on Sep. 1, 2016.

(51) Int. Cl. H04L 29/06

(52) U.S. Cl. CPC H04L 63/061; H04L 63/0442; H04L 63/0435; H04L 63/123; H04L 63/0807

(57) ABSTRACT

An exemplary system comprises a computing device processor configured for: determining, at a sending computing device, a public key, the public key associated with the sending computing device or a user associated with the sending computing device; accessing a collection of first keys, wherein each first key of the collection of first keys is mapped to each message in a sub-group of messages; determining a first tag, the first tag identifying the sub-group of messages; generating a collection of second keys based on the public key, the collection of first keys, and the first tag; determining a receiving computing device for receiving the sub-group of messages; generating a token based on recipient-specific information and tag-specific information, wherein the recipient-specific information comprises identification information associated with the receiving computing device, or a user associated with the receiving computing device, and the tag-specific information is associated with the first tag.

### CROSS-REFERENCE TO RELATED APPLICATIONS

This application claims priority to U.S. Provisional Application No. 62/382,289 filed on Sep. 1, 2016, and U.S. Provisional Application No. 62/382,300 filed on Sep. 1, 2016. The entire contents of the applications listed above are hereby incorporated in their entirety by reference for all purposes. This application is being filed simultaneously with U.S. patent application Ser. No. 15/691,387, and titled “Data Encipherment Prior to Recipient Selection,” the entire contents of which are hereby incorporated by reference in their entirety for all purposes. Any portion of any of these applications may be combined with any portion of the instant application.

### FIELD OF THE DISCLOSURE

The present disclosure generally relates to encryption methods and systems.

### BACKGROUND OF THE DISCLOSURE

A need exists for an improved data encryption and data sharing method that provides for accessing encrypted data with greater efficiency without compromising security. It is challenging to efficiently and securely share encrypted data with multiple parties under restrictions of time and resources. Accordingly, a need has arisen for an improved data encryption and secure sharing method.

### SUMMARY

This summary is provided to introduce a selection of concepts in a simplified form that are further described in below in the Detailed Description. This summary is not intended to identify key features or essential features of the claimed subject matter, nor is it intended to be used as an aid in determining the scope of the claimed subject matter. Other objects and features will be in part apparent and in part pointed out hereinafter. In some embodiments, a method is provided for generating keys. The method comprises: A method for generating keys, comprising: determining, at a sending computing device, a public key, the public key associated with the sending computing device or a user associated with the sending computing device; accessing a collection of first keys, wherein each first key of the collection of first keys is mapped to each message in a sub-group of messages; determining a first tag, the first tag identifying the sub-group of messages; generating a collection of second keys based on the public key, the collection of first keys, and the first tag; determining a receiving computing device for receiving the sub-group of messages; generating a token based on recipient-specific information and tag-specific information, wherein the recipient-specific information comprises identification information associated with the receiving computing device, or a user associated with the receiving computing device, and the tag-specific information is associated with the first tag. In some embodiments, the method further comprises: enciphering, at the sending computing device, messages, before the determining the receiving computing device; selecting the sub-group of messages from enciphered messages; and sending, from the sending computing device, the sub-group of messages. In some embodiments, the method further comprises: re-generating the collection of first keys from the collection of second keys based on a secret key, the secret key known only to the sending computing device or a user associated with the sending computing device.

In some embodiments, the method further comprises: sending the collection of second keys and the token to a key server, wherein the key server, not the sending computing device, generates a collection of third keys based on the collection of second keys and the token; and the key server, not the sending computing device, sends the collection of third keys to the receiving computing device, without access of a secret key known only to the sending computing device or a user associated with the sending computing device. Therefore, the key server performs the service of sending the collection of third keys to the receiving computing device without access to the sender's private key, thus, security or privacy for the sending computing device or user of the sending computing device is not compromised by the key server when the key server performs this service. In some embodiments, the receiving computing device re-generates the collection of first keys from the collection of third keys based on a secret key, the secret key known only to the receiving computing device or a user associated with the receiving computing device. In some embodiments, the collection of third keys cannot be sent to a third computing device or to a user unassociated with the sending computing device. In some embodiments, the collection of first keys cannot be re-generated from the collection of third keys at a third computing device or by a user unassociated with the receiving computing device. In some embodiments, the method further comprises: removing the token, wherein the receiving computing device cannot re-generate the collection of first keys from the collection of third keys.

In some embodiments, the method further comprises: enciphering new messages; and adding enciphered new messages to the sub-group of messages. In some embodiments, the method further comprises: determining a plurality of receiving computing devices; generating a plurality of tokens; generating a plurality of collections of third keys based on the tokens and the collection of second keys; and sending the collections of third keys to the receiving computing devices. In some embodiments, for the sending of the sub-group of messages, the collection of second keys is generated only once; and only one token is generated for each receiving computing device. In some embodiments, the messages are enciphered only once prior to generating the plurality of tokens and sending the plurality of collections of third keys to the plurality of receiving computing devices. In some embodiments, the sub-group of messages comprises a plurality of sub-groups of messages; the collection of first keys comprises a plurality of collections of first keys; the first tag comprises a plurality of first tags; and the collection of second keys comprises a plurality of collections of second keys. In some embodiments, each first key of the collection of first keys is used to encipher each message of the sub-group of messages. In some embodiments, each first key of the collection of first keys is used to re-generate each message of the sub-group of messages. In some embodiments, the identification information is selected from a group consisting of: an email address of the user associated with the receiving computing device, a phone number of the user associated with the receiving computing device, a social media address of the user associated with the receiving computing device, an Internet Protocol address of the receiving computing device, a physical address of the receiving computing device, a virtual address of the receiving computing device, and any combination thereof. In some embodiments, the token is generated based on a secret key, the secret key known only to the sending computing device or a user associated with the sending computing device. In some embodiments, the token is generated based on a receiving public key, the receiving public key associated with the receiving computing device.

In some embodiments, a system is provided for generating keys. The system comprises a computing device processor configured for: determining, at a sending computing device, a public key, the public key associated with the sending computing device or a user associated with the sending computing device; accessing a collection of first keys, wherein each first key of the collection of first keys is mapped to each message in a sub-group of messages; determining a first tag, the first tag identifying the sub-group of messages; generating a collection of second keys based on the public key, the collection of first keys, and the first tag; determining a receiving computing device for receiving the sub-group of messages; generating a token based on recipient-specific information and tag-specific information, wherein the recipient-specific information comprises identification information associated with the receiving computing device, or a user associated with the receiving computing device, and the tag-specific information is associated with the first tag.

In some embodiments, a non-transitory computer-readable medium is provided for generating keys. The non-transitory computer-readable medium comprising computer-executable code is configured for: determining, at a sending computing device, a public key, the public key associated with the sending computing device or a user associated with the sending computing device; accessing a collection of first keys, wherein each first key of the collection of first keys is mapped to each message in a sub-group of messages; determining a first tag, the first tag identifying the sub-group of messages; generating a collection of second keys based on the public key, the collection of first keys, and the first tag; determining a receiving computing device for receiving the sub-group of messages; generating a token based on recipient-specific information and tag-specific information, wherein the recipient-specific information comprises identification information associated with the receiving computing device, or a user associated with the receiving computing device, and the tag-specific information is associated with the first tag.

### BRIEF DESCRIPTION OF THE DRAWINGS

Reference is now made to the following detailed description, taken in conjunction with the accompanying drawings. It is emphasized that various features may not be drawn to scale and dimensions of various features may be arbitrarily increased or reduced for clarity of discussion. Further, some components may be omitted in certain figures for clarity of discussion.

FIG. 1A is a block diagram illustrating a method for encrypting data in accordance with some embodiments of the disclosure.

FIG. 1B is a block diagram illustrating a method for decrypting encrypted data by the owner of the data in accordance with some embodiments of the disclosure.

FIG. 1C is a block diagram illustrating a method for sharing encrypted data in accordance with some embodiments of the disclosure.

FIG. 1D is a block diagram illustrating a method for decrypting encrypted data by recipients in accordance with some embodiments of the disclosure.

FIG. 1E is a block diagram illustrating a method for sharing same encrypted data with multiple recipients in accordance with some embodiments of the disclosure.

FIG. 2 is a block diagram illustrating a computerized method for delivering encrypted data in accordance with some embodiments of the disclosure.

FIG. 3 is a block diagram illustrating a computerized method for delivering an encrypted message in accordance with some embodiments of the disclosure.

FIG. 4 is a block diagram illustrating a computerized method for registering a user in accordance with some embodiments of the disclosure.

FIG. 5 is a block diagram illustrating a computerized method for encrypting data in accordance with some embodiments of the disclosure.

FIG. 6 is a block diagram illustrating a computerized method for decrypting data in accordance with some embodiments of the disclosure.

FIG. 7 is a block diagram illustrating a computerized method for sharing data with multiple recipients in accordance with some embodiments of the disclosure.

FIG. 8 is an exemplary system diagram in accordance with some embodiments of the disclosure in accordance with some embodiments of the disclosure.

FIG. 9A is an exemplary functional diagram in accordance with some embodiments of this disclosure.

FIG. 9B is an exemplary functional diagram in accordance with some embodiments of this disclosure.

FIG. 10 is a flow diagram illustrating a method for enciphering data prior to knowing a recipient according to a specific example embodiment of the disclosure.

FIG. 11 is a flow diagram illustrating a method for managing bulk enciphered data sharing according to a specific example embodiment of the disclosure.

Although similar reference numbers may be used to refer to similar elements for convenience, it can be appreciated that each of the various example implementations may be considered distinct variations.

### DETAILED DESCRIPTION

For the purposes of promoting an understanding of the principles of the invention, reference is made to selected embodiments illustrated in the drawings and specific language will be used to describe the same. It will nevertheless be understood that no limitation of the scope of the invention is thereby intended; any alterations and further modifications of the described or illustrated embodiments, and any further applications of the principles of the invention as illustrated herein are contemplated as would normally occur to one skilled in the art to which the invention relates. At least one embodiment of the invention is shown in great detail, although it will be apparent to those skilled in the relevant art that some feature or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be reference to “advantages” provided by some embodiments of the present invention, other embodiments may not include those same advantages, or may include different advantages. Any advantages described herein are not to be construed as limiting to any of the claims.

Embodiments of the present disclosure generally include methods for encrypting data and delivering encrypted data. Embodiments include methods and systems for delivering encrypted data (e.g., e-mails, messages, files, binary strings and the like) to users (e.g. people, computers, tablet computers, cell phones, programs, software, and the like) or devices.

In some embodiments, encryption of data may mean a process of converting data into something that appears to be random and meaningless, which is called ciphertext. In some embodiments, encryption of data may include mathematical functions. In some embodiments, decryption of data may mean a process of converting ciphertext back to the original data. In some embodiments, decryption of data may include mathematical functions. In some embodiments, the word encipherment may be used synonymously with encryption. In some embodiments, the verb to encipher may be used synonymously with to encrypt. In some embodiments, the word enciphered may be used synonymously with encrypted. In some embodiments, the word ciphered may be used synonymously with encrypted. In some embodiments, the word decipherment may be used synonymously with decryption. In some embodiments, the verb to decipher may be used synonymously with to decrypt. In some embodiments, the word deciphered may be used synonymously with decrypted.

In some embodiments, a key means a cryptographic key. In some embodiments, a key may include a symmetric key, which is used to encrypt and decrypt data, and/or an asymmetric key, which is used in pair with another asymmetric key, in a way that one key is used to encrypt and the other key is used to decrypt. In some embodiments, a symmetric key may be 128 bits, 256 bits, or 512 bits; however, the description of the length of a symmetric key is provided by way of example only and not intended to be limiting. In some embodiments, a key may comprise a bit string, a random character, a string of random characters, a numerical number, a mathematical value, and/or any combination thereof. In some embodiments, key information may be used synonymously with key. In some embodiments, a key may refer to an asymmetric key, a symmetric key, a public key, a private key, a secret key, a re-encryption key, a transformation key, a content key, an access token, a recipient and tag specific token, a tag, and any combination thereof. In some embodiments, any key referred to herein may refer to any other key described in this disclosure. In some embodiments, a secret key may be used interchangeably with a private key. In some embodiments, key information may be a data owner's key information, or a recipient's key information, or a data owner's tag update key information. In some embodiments, secret key information may be a data owner's secret key information, or a recipient's secret key information, or a secret key generated by data owner for on behalf of the recipient, or a content key used to perform symmetric encryption and decryption. According to some embodiments, a key may be a public key such that the key may be made known to one or more parties other than the owner of the key. In some embodiments, a secret key may only be known to the owner of the secret key. In some embodiments, an access token may refer to a key. In some embodiments, an access token may be used interchangeably with a re-encryption key. In some embodiments, a recipient and tag specific token may be used interchangeably with a re-encryption key. In some embodiments, a token may be used interchangeably with a recipient and tag specific token. In some embodiments, a recipient and tag specific token may refer to a token created specifically for a recipient and/or a tag. In some embodiments, a token may be generated based on recipient-specific information and/or tag-specific information. In some embodiments, an access token may be used interchangeably with a transformation key. In some embodiments, a new encrypted content key may be used interchangeably with a transformation key. In some embodiments, a new ciphered key may be used interchangeably with a transformation key. In some embodiments, a tag may refer to a key. In some embodiments, a unique identifier for user may be used interchangeably with an identity of a user.

In some embodiments, an identity of a user may include, but not limited to, an email-address, or a phone number, or an Internet Protocol address, or a physical address or virtual address of a computing device, or any representation that is operable to uniquely identify a user. In some embodiments, an identity of a user may be unique in the system such that no two users in the system have same identities.

In some embodiments, a data owner may be referred to as sender. In some embodiments, a data owner may be referred to as a sending computing device. In some embodiments, a recipient may be referred to as a receiving computing device. In some embodiments, a sender, a data owner, and a recipient may be a person, a computing device, or a mixture of both a person and a computing device. Any computing device, system, apparatus, etc., may include, but not be limited to, a smart phone, a tablet, a laptop computer, a desktop computer, a personal digital assistant (PDA), a smart watch, a wearable device, a biometric device, an implanted device, a camera, a video recorder, an audio recorder, a touchscreen, a computer server or communication server, and/or the like. In some embodiments, a sender, a data owner, and a recipient may be a program authorized to work on behalf of the sender, the data owner, and the recipient, respectively.

In some embodiments, data may refer to a data collection. In some embodiments, data may refer to a data set. In some embodiments, data, data set, and data collection may be used interchangeably. A message, in some embodiments, may be used interchangeably with data. A message, in some embodiments, may be used interchangeably with file. In some embodiments, a file may be used interchangeably with data. According to some embodiments, a message may include, but is not limited to, a data file, a database object, a binary string, e-mail, a text message, a document, a word file, a picture, an audio file, a video file, and any combination thereof. According to some embodiments, data may be enciphered before one or more recipients are known to the sender.

Some embodiments of this disclosure may include a conditional key delegation method. The conditional key delegation method may comprise a data owner delegating the right (e.g., to a recipient) to decrypt encrypted data under certain conditions (e.g., time-based conditions, resource availability-based conditions, etc.). The conditional key delegation method may allow sharing of enciphered data without having to re-encipher data (e.g., by the sender, the recipient, an intermediate server, etc.). In some embodiments, the conditional key delegation method may allow sharing of enciphered data without having to re-encipher an enciphered key and/or enciphered data (e.g., by the sender, the recipient, an intermediate server, etc.). In some embodiments, the conditional key delegation may allow for a revocation of delegation after sharing data with the recipient or an intermediate server.

According to some embodiments, an enciphered key may be embedded into enciphered data. In some embodiments, embedding an enciphered key within an enciphered message may eliminate any need for storage space of said enciphered key. According to some embodiments, embedding an enciphered key within enciphered data may allow for a transmitting, storing, receiving, etc., an enciphered data set without any additional storage overhead. In some embodiments, embedding an enciphered key within enciphered data may allow for secure data sharing between a sender and a recipient.

In some embodiments, a limitless amount of enciphered data may be transferred between a sender and a recipient, such that there is no difference between the amount of time and resources used for transferring a single dataset versus an infinite number of dataset. In some embodiments, time and resources to share enciphered data may scale linearly with a number of recipients said enciphered data will be shared with. In some embodiments, enciphered data may be protected from unauthorized sharing due to non-transferrable conditional key delegation, which means a recipient who is authorized to access the enciphered data may not further delegate the authority to a third party.

In some embodiments, a recipient may further authorize a third party to access the enciphered data through transferrable conditional key delegation. In some embodiments, the transferrable conditional key delegation may allow the recipient to use his or her private key to further delegate. In some embodiments, the sender may limit how many times the recipient may delegate. For example, the sender may delegate to the recipient and allow the recipient to further delegate to a specific number of third parties. In some embodiments, third parties who are authorized by the recipient may not further delegate. In other embodiments, third parties who are authorized by the recipient may further delegate.

According to some embodiments of this invention, a key server may comprise an architecture where an administrator of a key server has no access to data. A key server may refer to a cloud server in some embodiments. In some embodiments, a key server may be prohibited from storing a data owner's secret key. In some embodiments, not storing a data owner's secret key on a key server may allow for enciphered data to be safe in an event where the security of said key server may be compromised. According to some embodiments, even when the key server is compromised, the key server may not allow an attacker to decipher enciphered data.

Some embodiments may include fully distributed key management. The fully distributed key management may comprise each user acting as its own authority and issuing keys to other users. In some embodiments, each user in the fully distributed key management may generate a re-encryption key using its own private key. In some embodiments, using a re-encryption key may allow revocation of access to enciphered data after sharing the enciphered data with a recipient, or may allow deciphering of enciphered data by the recipient or any other party that has no knowledge of the sender's private key. In some embodiments, using a re-encryption key may allow revocation of access to enciphered data after sharing said enciphered data.

According to some embodiments, a key server may be keyless, i.e., not store any keys. For example, the key server may not store any key used to encrypt data. In some embodiments, the key server may have no overhead (e.g., memory, processing and/or storage resources) for processing or otherwise performing operations on enciphered data. In some embodiments, the key server may not require memory for storing enciphered data. In some embodiments, not storing any key may improve the security of enciphered data. According to some embodiments, generation of re-encryption key may be independent of or decoupled from any transformation operations described herein.

In some embodiments, data may be encrypted only once. In some embodiments, the key used to encrypt data may be encrypted only once. In some embodiments, encryption of data may be performed only once even when the data is shared with multiple recipients. Data may be shared securely with multiple recipients after being encrypted once. Sharing with an additional recipient may not require re-encryption of the data. In some embodiments, generation of a recipient and tag specific token may be performed once for each recipient. In some embodiments, the data owner may not need to connect to the key server to complete the transformation operation. In some embodiments, transformation of a data set may be performed online on a key server where there is an active connection between the recipient and the key server.

In some embodiments, the data owner may not participate in the transformation of a data set after generating a recipient and tag specific token. The transformation of a data set without involving the data owner may not compromising the end-to-end security. The end-to-end security may mean that encryption keys are only known to the sender and the recipient, and no third parties may decipher the data being shared except the sender and the recipient. The trusted third party, such as a key server, may perform the transformation process for each recipient. In some embodiments, the data owner may securely delegate the authority to access the encrypted data to each recipient, and also securely delegate the authority to perform the transformation process to the trusted third party, at the same time, without allowing the entrusted third party to access the encrypted data. In some embodiments, a new recipient, after being authorized by the data owner, may access the encrypted data, without the data owner getting involved in the data sharing process. The data sharing process may remain secure without the involvement of the data owner.

According to some embodiments of this disclosure, keys may be exchanged securely through a secure key exchange process. The exchange may be conducted between any two parties (e.g., sender and recipient, first recipient and second recipient, sender/receiver and key server, etc.). The secure key exchange process may involve a two-way authentication. In some embodiments, the two-way authentication may involve operations using or on a digital signature. In some embodiments, the secure key exchange process may comprise a data owner sending a re-encryption key to a key server. In some embodiments, the secure key exchange process may involve a recipient sending the recipient's digital signature to the key server. In some embodiments, a re-encryption key may be generated using at least one of a data owner's secret key, a tag, a recipient's public key, and a recipient's identity. In some embodiments, using the data owner's secret key for generating a re-encryption key may ensure the end-to-end encryption (e.g., sender to recipient encryption). In some embodiments, a recipient may request a transformation key from a key server. In some embodiments, a key server may generate a transformation key. In some embodiments, a transformation key may be generated using a re-encryption key and a ciphered content key.

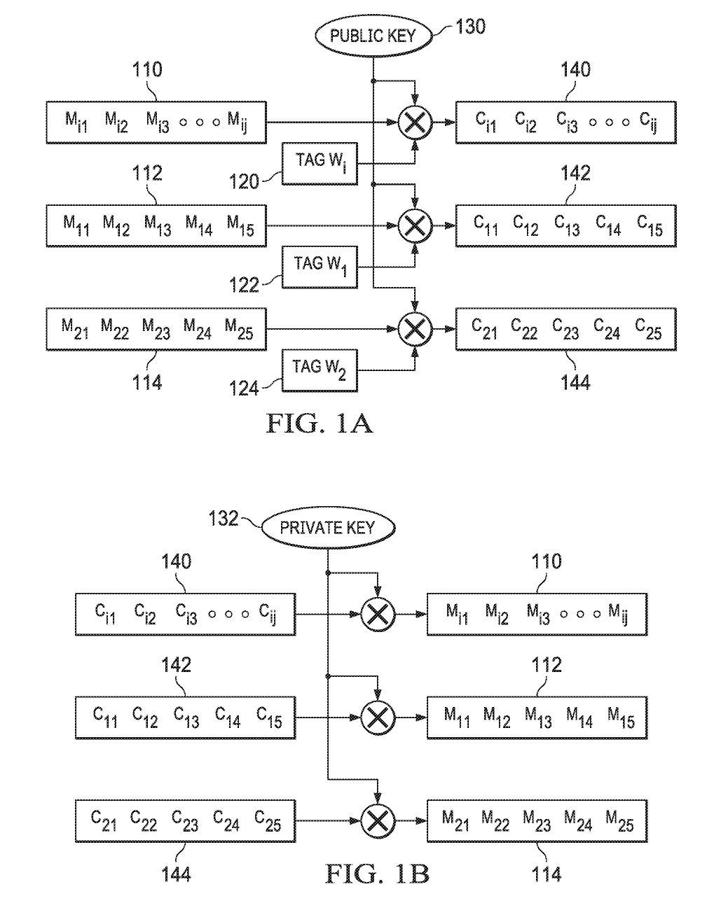

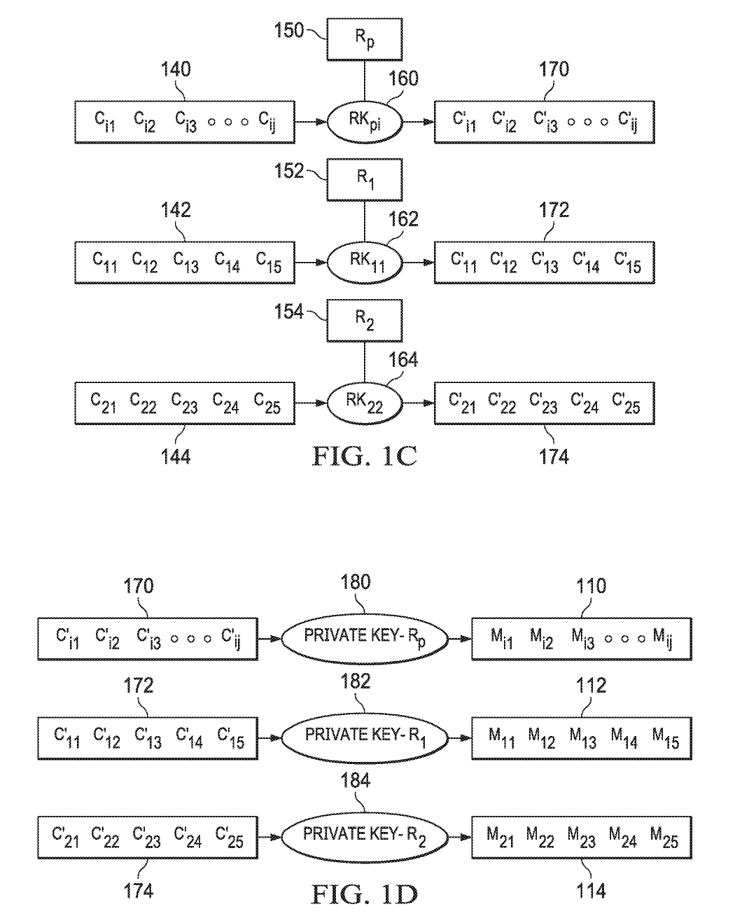

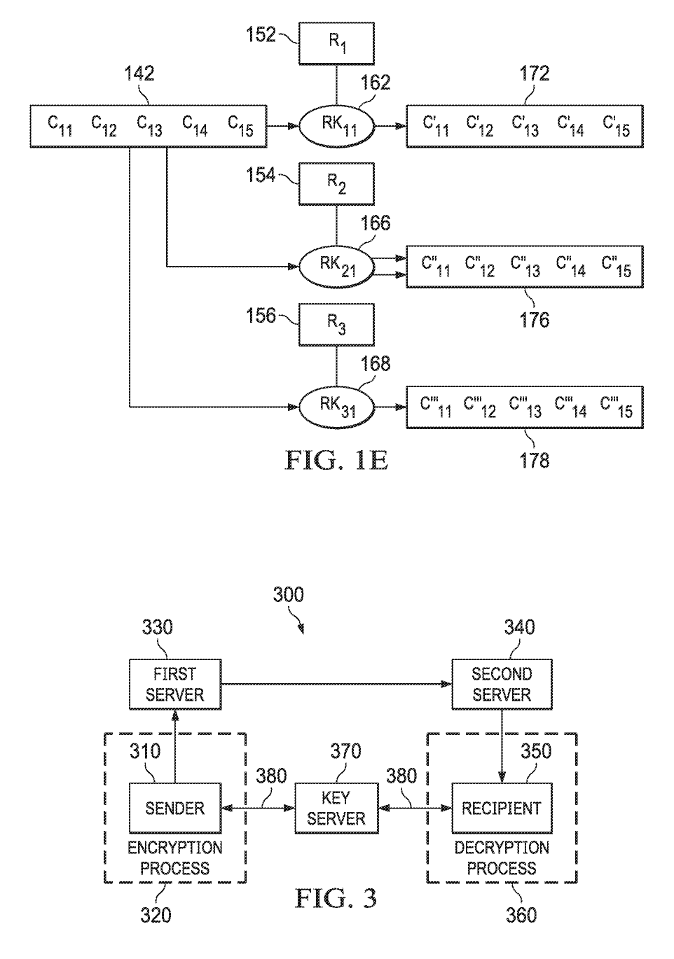

FIGS. 1A-1E illustrates example embodiments. FIGS. 1A-1E and the accompanying descriptions are provided by way of examples only and not intended to be limiting.

FIG. 1A provides a diagram illustrating a method 1 for encrypting data. In some embodiments, data may be encrypted using content key. A content key may be a symmetric key, which may be used to encrypt and decrypt data such that data encrypted by a content key may only be decrypted with the same content key. Each set of data may be encrypted using a specific content key such that each particular set of data has one corresponding content key. For better security, each set of data may be encrypted with a different content key. Each set of data may only be encrypted and decrypted by its corresponding content key. Content keys that are used to encrypt data may be randomly generated and not stored in a key server. A data owner, a device of the data owner, or a program or software on behalf of the data owner may generate content key randomly. Encrypting each set of data separately using its corresponding content key, instead of using one content key to encrypt multiple sets of data, may advantageously promote more secure data sharing by providing enhanced protection to each data. Encrypting each data with its corresponding content key may advantageously provide for conditional sharing without compromising security of other non-shared data, wherein the data owner may select data to be shared and share the selected data only.

As shown in FIG. 1A, the method 1 for encrypting a collection of data may transform a collection of keys 110 to a collection of ciphered keys 140 using a tag wᵢ 120 and the data owner's public key 130. In some embodiments, the data owner may have a public key and a private key, such that data may be encrypted using the data owner's public key and decrypted by the data owner's private key. Data may include keys, tags, files, data sets, and any combination thereof. The data owner's private key may remain confidential to the data owner, the data owner's computing device, and/or software or programs authorized by the data owner to act on behalf of the data owner. The data owner may have a full control of the data owner's private key. The data owner's public key may be made known to one or more parties other than the data owner. The data owner may share his or her public key with other people. The data owner and/or other people may use the data owner's public key to encrypt data; however, data encrypted using the data owner's public key may only be decrypted using the data owner's private key. The private key may never be derived from the public key. The private key may have various representations. In some embodiments, the private key may be a very large prime number. In some embodiments, the private key may be a random number within a very large range. In some embodiments, the private key may be 16 bytes or 32 bytes or 64 bytes. However, the size and representations of the private key are provided by way of examples only and not intended to be limiting. In some embodiments, the public key may be derived from the private key through mathematical computations; however, even when the public key is derived from the private key, the private key may not be computed back from the public key.

As shown in FIG. 1A, the tag w, 120 may be used to segregate, differentiate, or otherwise group together a set of data. In some embodiments, a content key may be a symmetric key. The data owner may create a subgroup of data and encrypt these data using content keys. The collection of keys 110 may comprise content keys M₁ₗ . . . Mᵢⱼ, which are used to encrypt corresponding data in the subgroup. The data owner may attach the tag wᵢ 120 to the collection of keys 110 to identify the collection of keys 110 as the collection of content keys for the subgroup of data. By attaching the tag wᵢ 120 to the collection of keys 110, the tag wᵢ 120 may be associated with the subgroup of data. The tag wᵢ 120 may be attached to the collection of keys 110 to segregate, differentiate, or otherwise group together the files in the subgroup from all other data. Associating the tag wᵢ 120 with the subgroup of files may advantageously promote conditional key delegation by providing for sharing of the subgroup of data only, instead of allowing access to all data of the data owner. Here, i is an integer that identifies a tag. For example, a tag w₁ 122 is different from a tag w₂ 124. In some embodiments, the data owner may use as many tags as needed such that i may start at 1 and increase to the number of subgroups created by the data owner. A tag may be a single binary string. In some embodiments, the size of the subgroup of data may not be related to the size of the tag. The collection of keys 110 comprises content keys Mᵢₗ . . . Mᵢⱼ and i is used to identify each content key because the tag wᵢ 120 is attached to the collection of keys 110. For a collection of keys, including the collection of keys 110 and the collection of ciphered keys 140, j is an integer that identifies a key in the collection. Accordingly, j may start at 1 and increase to the number of keys in a collection of keys. For example, as shown in FIG. 1A, a collection of keys 112 may comprise five content keys, therefore, j increases from 1 to 5 for the collection of keys 112 and content keys of the collection of keys 112 may be denoted as M₁₁, M₁₂, M₁₃, M₁₄, M₁₅. For the collection of keys 112, i is 1 because the tag w₁ 122 is attached to the collection of data 112. Similarly, i is 2 for a collection of keys 114, which comprises content keys M₂₁, M₂₂, M₂₃, M₂₄, M₂₅, because the tag w₂ 124 is attached to the collection of keys 112. The content keys, M₁₁, M₁₂, M₁₃, M₁₄, M₁₅, of the collection of keys 112, may be encrypted by the public key 130 with tag w₁ 122 to encrypted content keys, C₁₁, C₁₂, C₁₃, C₁₄, C₁₅. Similarly, the content keys, M₂₁, M₂₂, M₂₃, M₂₄, M₂₅, of the collection of keys 114 may be encrypted with tag w₂ 124 by the public key 130 to encrypted content keys, C₂₁, C₂₂, C₂₃, C₂₄, C₂₅. A collection of ciphered keys 142 may comprise encrypted content keys C₁₁, C₁₂, C₁₃, C₁₄, C₁₅, and a collection of ciphered keys 144 may comprise encrypted content keys C₂₁, C₂₂, C₂₃, C₂₄, C₂₅. The key server may not store any of content keys or encrypted content keys.

FIG. 1B provides a diagram illustrating a method 2 for decrypting encrypted data by the data owner. The encrypted content keys of the collection of ciphered keys 140 may be decrypted by the data owner's private key 132 and converted back to the collection of keys 110. For example, the encrypted content keys, C₁₁, C₁₂, C₁₃, C₁₄, C₁₅, of the collection of ciphered keys 142 may be decrypted by the data owner's private key 132 and converted back to the content keys M₁₁, M₁₂, M₁₃, M₁₄, M₁₅ of the collection of keys 112. Similarly, the encrypted content keys, C₂₁, C₂₂, C₂₃, C₂₄, C₂₅, of the collection of ciphered keys 144 may be decrypted by the data owner's private key 132 and converted back to the content keys M₂₁, M₂₂, M₂₃, M₂₄, M₂₅ of the collection of keys 114.

FIG. 1C provides a diagram illustrating a method 3 for sharing encrypted data. The data owner may share the collection of keys 110, to which the tag wᵢ 120 is attached, with a recipient Rₚ 150 by using a recipient specific token RKₚᵢ 160. The recipient and tag specific token RKₚᵢ 160 may be used by the recipient Rₚ 150 only to decrypt the data associated with the wᵢ 120 only. The encrypted content keys may not be decrypted without the recipient and tag specific token RKₚᵢ 160. The recipient and tag specific token RKₚᵢ 160 may be generated using at least one of the tag wᵢ 120, the data owner's private key 132, a public key of the recipient Rₚ 150, and an identity of the recipient Rₚ 150.

For the recipient and tag specific token RKₚᵢ 160 and the recipient Rₚ 150, p is an integer that identifies recipients, such that each recipient has a different number for p, and i is an integer that identifies the tag. For example, a recipient R₁ 152 is different from a recipient R₂154, and the recipient R₁ 152 may be assigned a recipient specific token RK₁₁ 162 when the data owner shares the subgroup of data associated with the tag w₁ 122. Similarly, the recipient R₂ 154 may be assigned a recipient specific token RK₂₂ 164 when the data owner shares the subgroup of data associated with the tag w₂ 124.

As shown in FIG. 1C, the encrypted content keys Cᵢₗ . . . Cᵢⱼ of the collection of ciphered keys 140 may be transformed to new encrypted content keys C′ᵢₗ . . . Cᵢⱼ of a collection of new ciphered keys 170 using the recipient and tag specific token RKₚᵢ 160. For example, the encrypted content keys C₁₁, C₁₂, C₁₃, C₁₄, C₁₅ of the collection of ciphered keys 142 may be transformed to new encrypted content keys C′₁₁, C′₁₂, C′₁₃, C′₁₄, C′₁₅ using the recipient and tag specific token RK₁₁ 162. By transforming the collection of ciphered keys 142 using the recipient and tag specific token RK₁₁ 162, the data owner may share the subgroup of data associated with the tag w₁ 122 with the recipient R₁ 152. A collection of new ciphered keys 172 may comprise the new encrypted content keys C′₁₁, C′₁₂, C′₁₃, C′₁₄, C′₁₅. Similarly, the encrypted content keys C′₂₁, C′₂₂, C′₂₃, C′₂₄, C′₂₅ of the collection of ciphered keys 144 may be transformed to new encrypted content keys C′₂₁, C′₂₂, C′₂₃, C′₂₄, C′₂₅ using the recipient and tag specific token RK₂₂ 164. A collection of new ciphered keys 174 may comprise the new encrypted content keys C′₂₁, C′₂₂, C′₂₃, C′₂₄, C′₂₅.

The recipient and tag specific token RKₚᵢ 160 may be generated by the data owner. Generation of the recipient and tag specific token RKₚᵢ 160 may be decoupled from encryption of files and decryption of files, such that the recipient and tag specific token RKₚᵢ 160 may be generated any time, even before data are encrypted or even before encrypted data are available to the recipient Rₚ 150. Decoupling of generation of recipient and tag specific tokens from encryption of data may advantageously promote the ease of sharing by limiting the data owner's involvement to generating the recipient and tag specific token RKₚᵢ 160 for the recipient Rₚ 150 only once. In addition, requiring recipient and tag specific tokens to decrypt the encrypted data may advantageously provide for revocation of sharing by the data owner. The data owner may revoke sharing with the recipient Rₚ 150 by removing the recipient and tag specific token RPₚᵢ 160 because the recipient Rₚ 150 may not be able to decrypt the encrypted data without the recipient and tag specific token RKₚᵢ 160 even when the recipient Rₚ 150 has access to the encrypted data. The recipient and tag specific token RKₚᵢ 160 may be known to the data owner or a trusted third party such as the key server. In some embodiments, an attacker who gains access to the recipient and tag specific token RKₚᵢ 160 may not decrypt the encrypted data unless the attacker possesses the recipient's private key 180 and/or data owner's private key 132, in addition to the encrypted data. In some embodiments, the recipient Rₚ 150 may be in possession of, or otherwise control, the recipient and tag specific token RKₚᵢ 160, after the recipient and tag specific token RKₚᵢ 160 is transferred to the recipient Rₚ 150. In some embodiments, the data owner may not revoke sharing after the recipient and tag specific token RKₚᵢ 160 is transferred to and retained by the recipient Rₚ 150. In some embodiments, the recipient and tag specific token RKₚᵢ 160 may be stored in the key server and may not be transferred to the recipient Rₚ 150. In some embodiments, to facilitate revocation, the key server may not present the recipient and tag specific token RKₚᵢ 160 to the recipient Rₚ 150 such that the recipient Rₚ 150 may not be in possession of the recipient and tag specific token RKₚᵢ 160 but only have access to the new ciphered keys 170. In order to be presented with the new ciphered keys 170, the recipient Rₚ 150 may need to authenticate himself or herself to the key server. The key server, which may store the recipient and tag specific token RKₚᵢ 160, may not have access to encrypted data, therefore may not decrypt encrypted data. However, the key server may facilitate for the recipient Rₚ 150 to access encrypted data.

In some embodiments, the recipient Rₚ 150 may not have access to the recipient-specific token RKₚᵢ 160. In some embodiments, to decrypt the encrypted data, the recipient Rₚ 150 may present the collection of ciphered keys 140 to the key server. The collection of ciphered keys 140 may be transmitted from the data owner to the recipient Rₚ 150 in various ways. In some embodiments, the collection of ciphered keys 140 may be stored together and/or transmitted together with encrypted data corresponding the encrypted content keys of the collection of ciphered keys 140. In other embodiments, the collection of ciphered keys 140 may be stored and/or transmitted separately from the corresponding encrypted data. In some embodiments, the collection of ciphered keys 140 and/or the corresponding encrypted data may be stored in a database, a cloud storage, or any other forms of data storage. In some embodiments, the collection of ciphered keys 140 may be sent from the data owner to the recipient Rₚ 150 via a different server. In some embodiments, the collection of ciphered keys 140 may be sent directly from the data owner from the recipient Rₚ 150.

In some embodiments, the key server may perform the transformation from the collection of ciphered keys 140 to the collection of new ciphered keys 170 and present the collection of new ciphered keys 170 to the recipient Rₚ 150 upon authentication of the recipient Rₚ 150. For example, the encrypted symmetric keys C₁₁, C₁₂, C₁₃, C₁₄, C₁₅ of the collection of ciphered keys 142 may be transformed to new encrypted content keys C′₁₁, C′₁₂, C′₁₃, C′₁₄, C′₁₅ using the recipient and tag specific token RK₁₁. After transforming the collection of ciphered keys 142 using the recipient and tag specific token RK₁₁ to the collection of new ciphered keys 172, the recipient R₁ 212 may use the collection of new ciphered keys 172 to recover the subgroup of data associated with the tag w₁ 122.

In some embodiments, the recipient and tag specific token RKₚᵢ 160 may be stored in the key server. In some embodiments, the key server may store the recipient and tag specific token RKₚᵢ 160 permanently. In other embodiments, the key server may store the recipient and tag specific token RKₚᵢ 160 for a limited period of time. After the recipient and tag specific token RKₚᵢ 160 is removed from the key server, or otherwise disabled by the data owner, the recipient Rₚ 150 may no longer decrypt the encrypted data even if the recipient Rₚ 150 was able to decrypt the encrypted data before the recipient and tag specific token RKₚᵢ 160 was removed or otherwise disabled by the data owner. The key server may not perform the transformation from the collection of ciphered keys 140 to the collection of new ciphered keys 170 without the recipient and tag specific token RKₚᵢ 160. In some embodiments, the key server may not store the collection of new ciphered keys 170.

In some embodiments, a large amount of data may be shared with the recipient Rₚ 150 using the tag wᵢ 120. Even after the recipient and tag specific token RKₚᵢ 160 is generated, the data owner may share additional data with the recipient by associating the additional data with the tag wᵢ 120. Because all data associated with the tag wᵢ 120 may be decrypted using the recipient specific token RKₚᵢ 160, the data owner may not need to generate any additional recipient specific and tag specific token. The number of recipient specific tokens generated may be proportional to the number of tags used multiplied by the number of recipients. The number of recipient and tag specific tokens depending only on the number of tags and the number of recipients may advantageously promote cost-efficient sharing without compromising security.

FIG. 1D provides a diagram illustrating a method 4 for decrypting encrypted data by recipients. The recipient Rₚ 150 may decrypt the new encrypted content keys C′ᵢₗ . . . C′ᵢⱼ in the collection of new ciphered keys 170 using his or her private key-Rₚ 180 and convert them back to the content keys Mᵢₗ . . . Mᵢⱼ in the collection of keys 110. For example, since the new encrypted content keys C′₁₁, C′₁₂, C′₁₃, C′₁₄, C′₁₅ of the collection of new ciphered keys 172 were transformed from the encrypted content keys C₁₁, C₁₂, C₁₃, C₁₄, C₁₅ using the recipient and tag specific token RK₁₁ 162 for R₁ 152, the new encrypted content keys C′₁₁, C′₁₂, C′₁₃, C′₁₄, C′₁₅ of the collection of new ciphered keys 172 may be converted back to the content keys M₁₁, M₁₂, M₁₃, M₁₄, M₁₅ using the recipient R₁'s private key, the private key-R₁ 182. Similarly, the new encrypted content keys C′₂₁, C′₂₂, C′₂₃, C′₂₄, C′₂₅ of the collection of new ciphered keys 172, which were transformed using the recipient and tag specific token RK₂₂ 164 for R₂ 214, may be converted back to the content keys M₂₁, M₂₂, M₂₃, M₂₄, M₁₅ using the private key-R₂ 184. In some embodiments, the key server or untrusted third party may not decrypt encrypted data even when the key server has access to the collection of ciphered keys 140 and/or the collection of new ciphered keys 170 because the key server does not have access to the private key-Rₚ 180.

FIG. 1E provides a diagram illustrating a method 5 for sharing same encrypted data with multiple recipients. As in the example shown in FIG. 1E, the data owner may share the subgroup of data associated with the tag w₁ 122 with multiple recipients by generating multiple recipient and tag specific tokens. Each set of the subgroup of data associated with the tag w₁ 122 are encrypted by the content keys M₁₁, M₁₂, M₁₃, M₁₄, M₁₅ of the collection of keys 112. The content keys M₁₁, M₁₂, M₁₃, M₁₄, M₁₅ of the collection of keys 112 are further encrypted using the data owner's public key 130 and tag W₁ to the encrypted content keys C₁₁, C₁₂, C₁₃, C₁₄, C₁₅ of the collection of ciphered keys 142. The data owner may share the encrypted content keys C₁₁, C₁₂, C₁₃, C₁₄, C₁₅ of the collection of ciphered keys 142 with multiple recipients, R₁, R₂, and R₃, by generating recipient and tag specific tokens RK₁₁, RK₂₁, RK₃₁. The encrypted content keys C₁₁, C₁₂, C₁₃, C₁₄, C₁₅ of the collection of ciphered keys 142 may be transformed to C′₁₁, C′₁₂, C′₁₃, C′₁₄, C′₁₅ of the collection of new ciphered keys 172 using RK₁₁ 162, C″₁₁, C″₁₂, C″₁₃, C″₁₄, C″₁₅ of the collection of new ciphered keys 176 using RK₂₁ 166, and C′″₁₁, C′″₁₂, C′″₁₃, C′″₁₄, C′″₁₅of the collection of new ciphered keys 178 using RK₃₁ 168. C₁ⱼ,C′₁ⱼ, C″ᵢⱼ, and C′″₁ⱼ may have different representations. Each of recipients, R₁, R₂, and R₃, may use the collection of new ciphered keys 172, the collection of new ciphered keys 176, and the collection of new ciphered keys 178 respectively to decrypt the subgroup of data associated with the tag w₁ 122 using each recipients' private key. This illustration is provided by way of example only and not intended to be limiting.

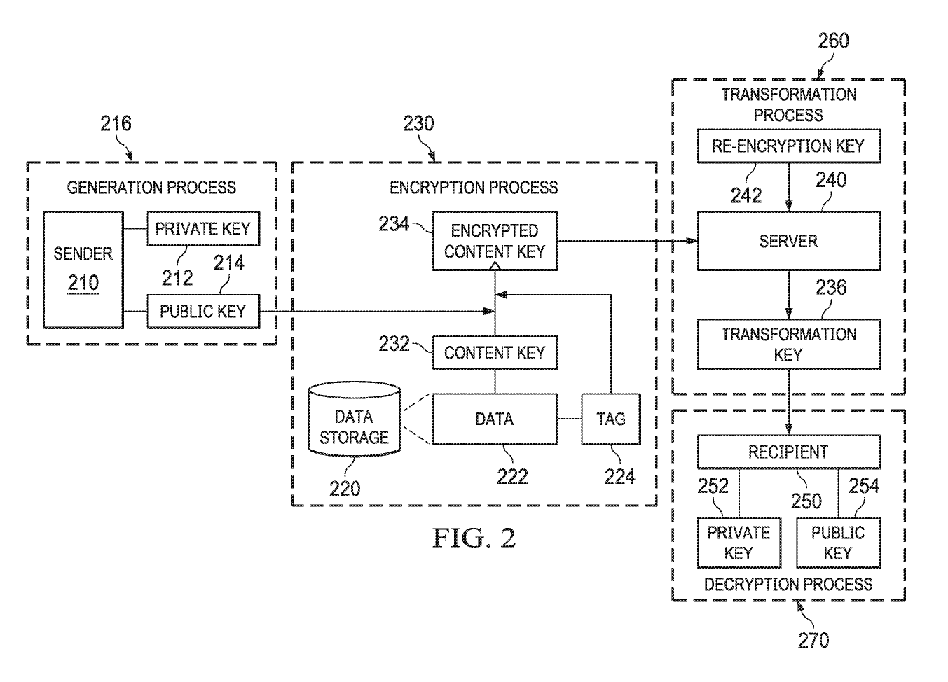

FIG. 2 provides a block diagram illustrating a method 200 for sharing encrypted data. The method 200 for delivering encrypted data may comprise a generation process 216, an encryption process 230, a transformation process 260, and a decryption process 270. The generation process 216 may comprise a sender 210 generating a private key 212 and a public key 214. The sender's private key 212 may be a cryptographic key and may remain confidential to the sender 210, and may be obtained only from the sender 210. The sender's public key 214 may be a cryptographic key that is made available to the public via a publicly accessible repository or directory, and/or may be obtained directly from the sender. The sender 210 may send his or her public key 214 to a server 240. In some embodiments, the private key 212 and the public key 214 may be random characters. In some embodiments, the private key 212 may be generated from a random number generator. In some embodiments, the public key 214 may be derived from private key 212 based on a cryptographic algorithm, such as Elliptic Curve Cryptographic Algorithm. However, the description of the public key 214 being derived from the private key 212 based on the above-mentioned algorithms is provided by way of example only and not intended to be limiting. In some embodiments, the private key 212 and the public key 214 may be generated as a pair such that data encrypted with the public key 214 may only be decrypted with the private key 212.

In some embodiments, following the generation process 216, data 222 may undergo the encryption process 230. The data 222 may have a tag 224 attached to it. The tag 224 may be randomly generated. In some embodiments, the tag 224 may be uniquely associated with the data 222. In some embodiments, the tag 224 may have no mathematical relationship with the data 222. In some embodiments, a content key 232 may be randomly generated. In some embodiments, the sender 210 may generate the content key 232. In some embodiments, the content key 232 may encrypt the data 222. In some embodiments, the content key 232 may comprise a set of content keys. In some embodiments, the data 222 may comprise a set of files. In some embodiments, the content key 232 may comprise multiple symmetric keys such that each file in the data 222 is encrypted with its corresponding symmetric key. In some embodiments, encryption by the content key 232 may be based on a symmetric encryption algorithm, such as Advanced Encryption Standard. However, this algorithm is provided here by way of example only and not intended to be limiting. In some embodiments, the content key 232 may be used only once. Using the content key 232 only once may advantageously strengthen the security. In some embodiments, the encryption process 220 may not require storing the content key 232 in the server 240. The encryption process 220 without storing the content key 232 in the server 240 may advantageously promote protection of user's data privacy. In some embodiments, the encryption process 220 may be performed without prior knowledge of a recipient 250. In some embodiments, the sender 210 may encrypt the content key 232 with its public key 214 and associate the content key 232 with the tag 224, so that the encrypted content key 234 may be decrypted with the sender's private key 212.

In some embodiments, after the encryption process 230, the server 240 may perform the transformation process 260. In some embodiments, the transformation process 260 may transform the encrypted content key 234 to a transformation key 236, using a re-encryption key 242 and the encrypted content key 234. In some embodiments, the sender 210 may generate the re-encryption key 242. In some embodiments, the re-encryption key 242 may be independently generated and operable from the data 222. A different re-encryption key 242 may be generated for each tag 224. A different re-encryption key 242 may be generated for each recipient 250. The re-encryption key 242 may be generated using the sender's private key 212, the tag 224, the recipient's public key 254, and an identity of the recipient 250. In some embodiments, the re-encryption key 242 may be transferred to the recipient 250 through the server 240. In some embodiments, the re-encryption key 242 may be stored in the server 240. In some embodiments, the transformation process 260 may be performed by a different entrusted party, including the sender 210.

In some embodiments, the transformation key 236 may have a different representation from the content key 232 and/or the encrypted content key 234. In some embodiments, a representation may include, but not limited to, a mathematical value, a sequence of numbers and/or characters, a bit string, and any combination thereof. In some embodiments, the transformation process 230 may comprise a mathematical function, which computes a transformation key 236 from the encrypted content key 234 and the re-encryption key 242. In some embodiments, the transformation process 230 may comprise a sequence of mathematical functions to generate a transformation key 236. In some embodiments, the transformation key 236 may have a representation unique to the recipient 250. In some embodiments, having a representation unique to the recipient 250 may mean that the representation of the transformation key 236 transmitted to recipient 250 is different from transformation keys that may be delivered to any other recipient. In some embodiments, the transformation key 236 may remain confidential to the recipient 250. However, even when hackers gain access to the transformation key 236, hackers may not access the data 222 without the recipient's private key 252, which remains confidential to the recipient 250, hackers may only use brute force method to recover the content key 232, which is required to decrypt the data 222.

In some embodiments, the decryption process 270 may follow the transformation process 260. The data 222 may be decrypted by either the sender's private key 212, or the recipient's private key 252. The sender 210 may decrypt the encrypted content key 234 using its private key 212 to recover the content key 232, and using the content key 232, the sender 210 may decrypt the data 222.

In some embodiments, the data 222 may be decrypted by the recipient's private key 252 as shown in FIG. 2. After the transformation process 230, the transformation key 236 may be transmitted to the recipient 250. In some embodiments, the decryption process may comprise the recipient 250 decrypting the transformation key 236 with the recipient's private key 252, which remains confidential to the recipient 250. In some embodiments, the recipient 250 may recover the content key 232 by decrypting the transformation key 236 with the recipient's private key 252. In some embodiments, the recipient 250 may decrypt the data 222 by using the content key 232 after recovering the content key 232. In some embodiments, requiring the recipient's private key 252 to decrypt the encrypted data may protect the data from a man-in-the-middle attack because the recipient's private key 252 is unknown to the man-in-the-middle.

The server 240 may not need to store any of the content key 232, the encrypted content key 234, and/or the transformation key 236. Hackers may not access the data 222 by attacking the server 240 because the server 240 may not have any of the content key 232, the encrypted content key 234, and/or the transformation key 236. In some embodiments, the re-encryption key 242 may be store in the server 240; however, the re-encryption key 242 may not have any mathematical relationship with the content key 232 and/or the encrypted content key 234 and may not be used directly to decrypt the encrypted content key 234.

As shown in FIG. 2, the sender 210 may not be required to engage in the decryption process 270 for the recipient 250. After generating the re-encryption key 242, the recipient 250 may not need the sender 210 to decrypt the encrypted data 222. Not involving the sender 210 in the decryption process 260 may advantageously promote the ease of sharing for the sender 210 without compromising security. Furthermore, the sender 210 may share a large number of data using one re-encryption key, without re-encrypting the data, as long as the data are associated with the same tag.

In some embodiments, the sender 210 and/or the recipient 250 may use variants of their private keys, 212 and/or 252. In some embodiments, the variant may be based on the identity, for example, an Identity Base Encryption (IBE) key. In some embodiments, encrypting the IBE key may be deferred until the recipient 250 registers with the server 240.

In some embodiments, the server 240 may obtain the public key 254 of the recipient 250. In some embodiments, the recipient 250 may need to register with the server 240 to access the encrypted data 222.

Requiring the recipient's private key 252 to decrypt the transformation key 234 may advantageously protect the data 222 from hackers. Even when hackers obtain the re-encryption key 242, the re-encryption key 242 alone may not grant access to the data 222 because the re-encryption key 242 may not be used to decrypt the data 222. The sender's private key 212 or the recipient's private key 252 may be required to decrypt the encrypted content key 234 or the transformation key 236 to recover the content key 232, which may be used to decrypt the data 222. The sender's private key 212 and the recipient's private key 252 may remain confidential to the sender 210 and the recipient 250, respectively.

The method 200 for sharing encrypted data may advantageously facilitate revoking the access to the data 222 by the sender 210. The sender may revoke the access to the data 222 by removing the re-encryption key 242. Because the re-encryption key 242 may be generated by using the tag 224, the sharing of the data 222 associated with the tag 224 may be revoked by the sender 210. The sender 210 may revoke the sharing before or after the recipient has access to the data 222. In some embodiments, the sender 210 may share the data 222 for a limited period of time (e.g., seconds, minuets, days, weeks, etc.) by removing the re-encryption key 242 after the limited period of time. In some embodiments, the sender 210 may set an expiration for the re-encryption key 242 such that the recipient 250 may no longer decrypt the data 222 once the re-encryption key 242 expires.

FIG. 3 provides a block diagram illustrating a method 300 for delivering an encrypted message. In some embodiments, the method 300 for delivering an encrypted message may comprise an encryption process 320 and a decryption process 360. A sender 310 may create a message using a computing device, e.g., a smart phone, a tablet, a laptop computer, a desktop computer, a personal digital assistant (PDA), a smart watch, a wearable device, a biometric device, an implanted device, a camera, a video recorder, an audio recorder, a touchscreen, a computer server or communication server, and/or the like. In some embodiments, the encryption process 320 may include the computing device prompting the sender 310 to encrypt the message created by the sender 310. In some embodiments, the encryption process 320 may further include an encryption mode which, when activated, may allow the device to encrypt the message created by the sender 310 with enhanced security, such that a brute-force attack may be drastically more difficult. In some embodiments, the sender 310 may use the device to encrypt the message on the computing device. In some embodiments, the sender 310 may use content keys to encrypt the message. A content key may be a cryptographic key different from the sender's private key and public key. In some embodiments, the content key may be a symmetric key. The sender 310 may further encrypt the content key with his or her public key. The sender 310 may send the encrypted message to a first server 330. In some embodiments, the encrypted message may be further delivered from the first server 330 to a second server 340. In some embodiments, the first server 330 may be a mail server, storage server, database, and the like. In some embodiments, the second server 340 may be a mail server, storage server, database, and the like. In some embodiments, the first server 330 and the second server 340 may be the same server. In other embodiments, the first server 330 and the second server 240 may be different servers. The encrypted message may remain secure from the sender 310 to a recipient whether at-rest or in-transit regardless of means of data retention or transit.

In some embodiments, using the computing device, the sender 310 may generate an access token for a recipient 350 whom the sender 310 designates to send the encrypted message. In some embodiments, an access token may be a cryptographic or encrypted key created using at least one of the sender's private key, the recipient's identity, and/or the recipient's public key. In some embodiments, the key server 370 may generate an access token. In other embodiments, the sender 310 may create an access token using the computing device and send the access token to the key server 370. The access token may be stored in the key server 370. The key server 370 may transform the encrypted content key to a transformation key using the access token.

In some embodiments, the encrypted message may be decrypted by the recipient 350 during the decryption process 360. In some embodiments, the decryption process 360 may include the recipient 350 receiving the encrypted message from the second server 340 and the transformation key from the key server 370. In some embodiments, the decryption process 360 may further comprise the recipient 350 decrypting the encrypted message using the transformation key. In order to decrypt the encrypted message using the transformation key, the recipient 350 may use his or her private key to decrypt the transformation key to recover the content key, which was used to encrypt the message. The recipient 350 may decrypt the message with the content key.

In some embodiments, keys may be exchanged securely using an authentication process 380. The authentication process 380 may be a two-way authentication process. In some embodiments, the two-way authentication process may involve a digital signature. The authentication process 380 may be employed to verify the request of the recipient 350 to receive the message and the request of the sender 310 to send the access token to the recipient 350. The authentication process 380 may verify the request of the recipient 350 by checking that the recipient's signature is correct using the recipient's public key and that recipient's private key may be used to decrypt the transformation key. The transformation key may be computed using the access token, which may be generated using the sender's private key and/or the recipient's public key, and therefore the transformation key may be decrypted only with the recipient's private key. The authentication process 380 may verify the request of the sender 310 by verifying the sender's signature is correct using the sender's public key. In some embodiments, using the sender's secret key for generating an access token may ensure end-to-end encryption, i.e., encryption from the sender 310 to the recipient 350. In some embodiments, the authentication process 380 may allow the sender 310 and the recipient 350 to verify the response of the key server 370 by verifying the key server's signature is correct using the key server's public key.

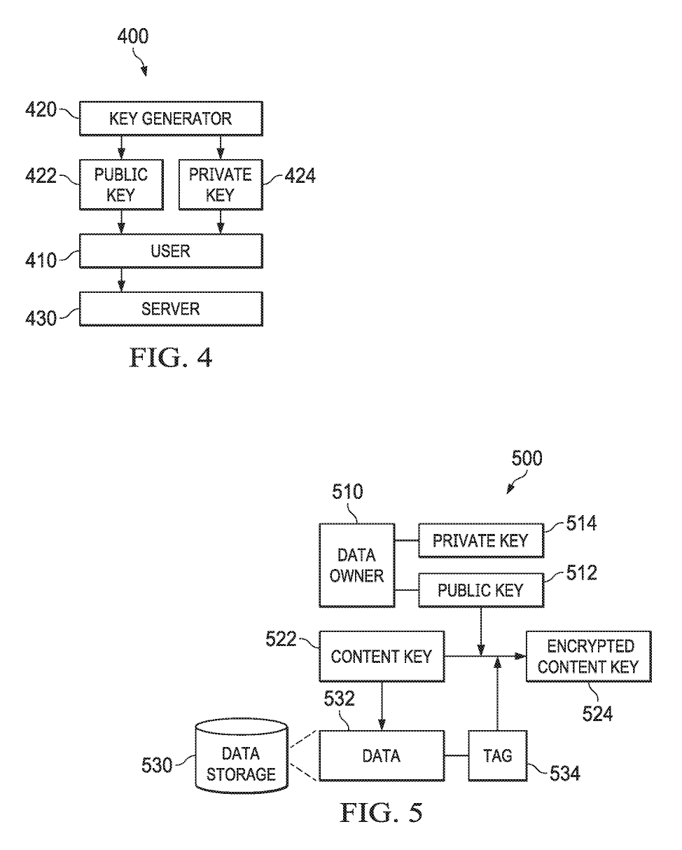

FIG. 4 provides a block diagram illustrating a method 400 for registering a user to a server. As shown by FIG. 4, a user 410 may use a key generator 420 to generate a public key 422 and a private key 424. In some embodiments, the key generator 420 may be a part of the user's device. In other embodiments, the key generator 420 may be a part of a server 430. In other embodiments, the key generator 420 may be a different device than the user's device and the server. The public key 422 and the private key 424 may be cryptographic keys. In some embodiments, the public key 422 may be generated by ECC (Elliptical Curve Cryptographic) Algorithm from the private key 424. In some embodiments, the private key 424 may be a randomly generated number within the specification of an elliptical curve. However, generating the public key 422 and the private key 424 using an elliptical curve is provided as an example only and not intended to be limiting.

In some embodiments, the private key 424 may be further transformed to a variant private key. A variant private key may include a longer key, a more complex key, and/or a differently formatted key derived from the private key 424. The private key 424 may be transformed to a variant private key by a key deviation function, which may stretch, complicate, and/or otherwise transform the private key 424. In some embodiments, the private key 424 may include all variants of the private key 424. The sender 410 may send the public key 422 to the server 430 to complete registration. In some embodiments, the private key 424 may be encrypted. In some embodiments, the private key 424 may be stored in the user's device. The private key 424 may remain confidential to the user 410.

FIG. 5 provides a block diagram illustrating a method 500 for encrypting data. As shown in FIG. 5, in some embodiments, a data owner 510 may select data 532 by selecting a tag 534 and encrypt the data 532 with a content key 522. In some embodiments, the data 532 may comprise one or more set of data. In some embodiments, a set of data may include, but not be limited to, a data file, a database object, a binary string, e-mail, a text message, a document, a document, a word file, a picture, an audio file, a video file, and any combination thereof. In some embodiments, the tag 534 may be attached to and/or be associated with the data 532. In some embodiments, the tag 534 may comprise a random binary string. In some embodiments, the tag 534 may be specific to the data 532 in a way the data 532 may be identified with the tag 534. In some embodiments, the data owner 510 may select the data 532 by attaching the tag 534. In some embodiments, the tag 534 may be mapped to a group of files in the data 532. In some embodiments, the tag 534 may be publicly known. In some embodiments, the tag 534 may be known by the data owner 510 or trusted third party.

In some embodiments, the content key 522 may be used to encrypt the data 532. The content key 522 may be a cryptographic key. In some embodiments, the content key 522 may be randomly generated. In some embodiments, the content key 522 may be generated by the data owner 510. In other embodiments, the content key 522 may be generated by a server or a device other than the key server. In some embodiments, the content key 522 may be a symmetric key, which may mean a cryptographic key that may be used to both encrypt and decrypt data. In some embodiments, the data 532 may be encrypted by the content key 522. In some embodiments, the Advanced Encryption Standard may be used to encrypt the data 532. In some embodiments, the encrypted data 532 may be stored in a data storage 530. In some embodiments, the data storage 530 may include, but not limited to, a cloud storage, a database, a USB, a computer storage device, a hard drive, and any combination thereof.

In some embodiments, after encrypting the data 532, the data owner 510 may encrypt the content key 522 with the data owner's public key 512 and attach the tag 534 to create a encrypted content key 524. Both the encrypted content key 524 and the encrypted data 532 may be transferred to the recipient.

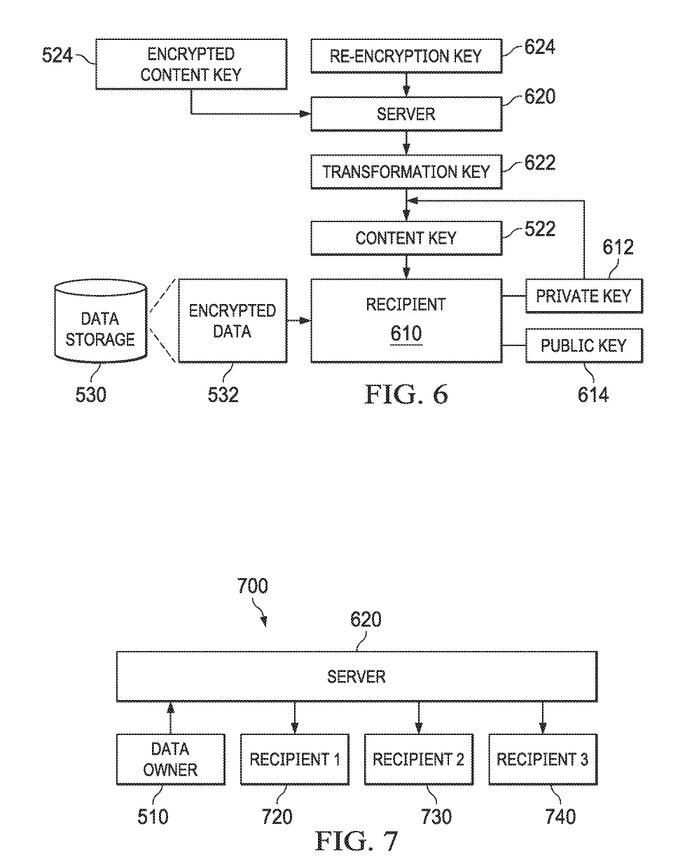

FIG. 6 provides a block diagram illustrating a method 600 for decrypting data. The encrypted data may be decrypted either by the data owner 510 using the private key 512, or by a recipient 610 using a transformation key 622 and the recipient's private key 612. The data owner may decrypt the encrypted data 532 by decrypting the encrypted content key 524 with the data owner's private key 514 to recover the content key 522. Using the content key 522, the data owner 510 may decrypt the encrypted data 532.

To share the data 532, the data owner 510 may generate a re-encryption key 624. The re-encryption key 624 may be generated using at least one of the data owner's private key 514, the recipient's public key 614, the tag 534, and an identity of the recipient 610. In some embodiments, the recipient 610 may present the encrypted content key 524 to a server 620. The server 620 may compute the transformation key 622 using the encrypted content key 524 and the re-encryption key 624. In some embodiments, the server 620 may present the transformation key 622 to the recipient 610. In other embodiments, the server 620 may transfer the transformation key 622 to the recipient 610.

As shown in FIG. 6, the recipient 610 may decrypt the encrypted data 532 using the transformation key 622. The recipient 610 may retrieve, or otherwise access, the encrypted data 532 from the data storage 530. In some embodiments, the transformation key 622 may be used to recover the content key 522, which may be used to decrypt the data. The recipient 610 may decrypt the transformation key 622 with the recipient's private key 612. After recovering the content key 522 from the transformation key 622, the recipient 610 may decrypt the encrypted data 532 with the content key 522. In some embodiments, the server 620 may authenticate that the re-encryption key 624 generated by data owner 510 by verifying the digital signature of the data owner 510 using the data owner's public key 512. The data owner 510 may generate and send the re-encryption key 624 to the server 620, and the server 620 may verify digital signature of the data owner 510. When the data owner 510 receives the acknowledgement from the server 620, the data owner 510 may authenticate the acknowledgement of server 620 by verifying the digital signature of the server 620 using the server's public key. When the recipient 610 requests the server 620 to generate the transformation key 622, the server 620 may authenticate the request of recipient 610 by verifying digital signature of the recipient 610 using the recipient's public key 614 before servicing the request. When the recipient 610 receives the transformation key 622 from the server 620, the recipient 610 may verify digital signature of the server 620. In other embodiments, an entrusted entity other than the server 620 may perform the authentication.

FIG. 7 provides a block diagram illustrating a method 700 for sharing data with multiple recipients. In some embodiments, a data owner 510 may share data with multiple additional recipients (e.g., 720, 730, 740). In some embodiments, the data owner may encrypt the data 532 only once for multiple recipients 720, 730, 740. The data owner may not need to encrypt the data 532 again for each additional recipients (e.g., 720, 730, 740). In some embodiments, the encrypted data 532 may remain stored in the data storage 530 and not be transferred through the server 620. The data owner 510 may generate multiple re-encryption keys to share the data with multiple recipients. A new re-encryption key may be generated for each additional recipient. For example, a new re-encryption key may be generated for the recipient 720, using an identity of the recipient 720 and/or a public key of the recipient 720. The server 620 may transform the encrypted content key 524 using the re-encryption key for each recipient to his or her respective transformation key for each of the additional recipients (e.g., 720, 730, 740). For example, the server 620 may transform the encrypted content key 524 to a new transformation key using the re-encryption key generated for the recipient 720. Each of the additional recipients (e.g., 720, 730, 740) may receive a respective transformation key. Each of the additional recipients (e.g., 720, 730, 740) may use his or her private key to recover the content key 522 from the his or her transformation key. In some embodiments, encrypting the data only once may advantageously facilitate sharing data by saving time and resources involved in encrypting data without compromising security.

In some embodiments, the method for sharing data with multiple recipient 700 may be used to collectively edit a document without compromising the confidentiality of the document. In some embodiments, an owner of a document (e.g., the data owner of FIGS. 5, 6, and 7) may share the document using the method 700 for sharing data with multiple recipients and after some or all the edits are made to the document, the owner of the document may revoke the keys. In some embodiments, a document may refer to any type of file.

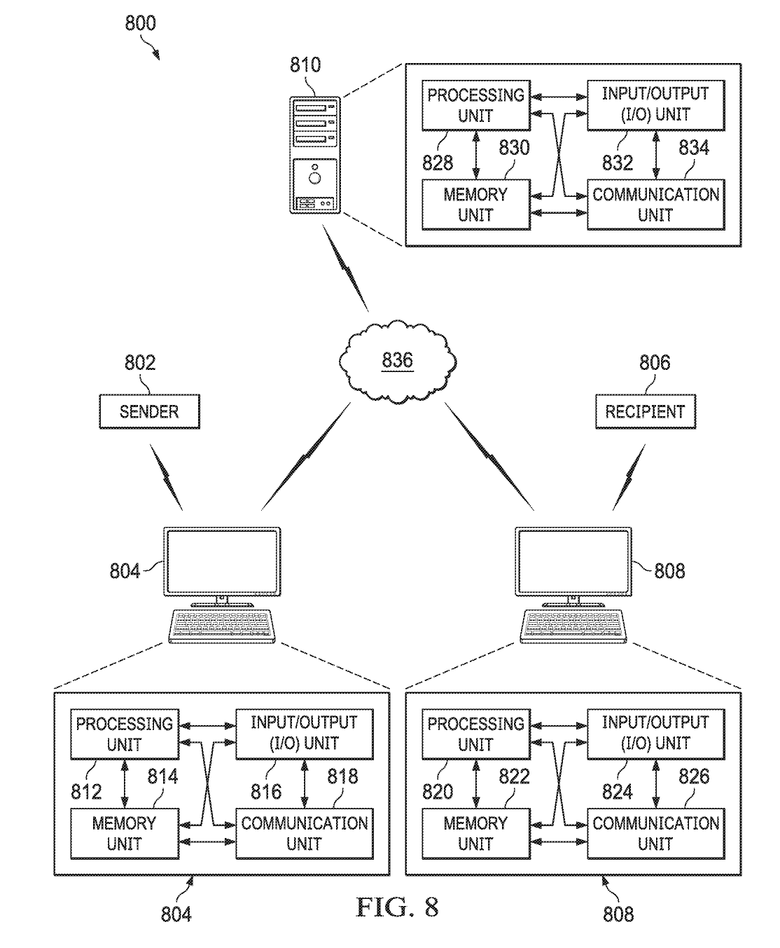

FIG. 8 illustrates a more detailed system for enabling between a sender 802 and the recipient 806 as described herein (e.g. as described in the illustrative examples of FIGS. 1-7). Although two users 802 and 806 are illustrated in the presently described embodiment, the concepts disclosed here may be similarly applicable to an embodiment that includes more than two users.

In some embodiments, the system 800 may include the sender, the recipient, and a server. In some embodiments, the sender 802 and the recipient 806 may each use a computing device 804, 808 which may include, but not be limited to, a smart phone, a tablet, a laptop computer, a desktop computer, a personal digital assistant (PDA), a smart watch, a wearable device, a biometric device, an implanted device, a camera, a video recorder, an audio recorder, a touchscreen, a computer server or communication server, and/or the like. In some embodiments, the sender's device 804 and/or the recipient's device 808 may each include a plurality of devices as described herein. In some embodiments, the sender's device 804 may include various elements of a computing environment as described herein. For example, the sender's device 804 may include a processing unit 812, an memory unit 814, an input/output (I/O) unit 816, and/or a communication unit 818. Each of the processing unit 812, the memory unit 814, the input/output (I/O) unit 816, and/or the communication unit 818 may include one or more subunits as described herein for performing operations associated with providing relevant contextual features to the sender 802 during delivery of encrypted data.

In some embodiments, the recipient's device 808 may include various elements of a computing environment as described herein. For example, the recipient's device 808 may include a processing unit 820, a memory unit 822, an input/output (I/O) unit 824, and/or a communication unit 826. Each of the processing unit 820, the memory unit 822, the input/output (I/O) unit 824, and/or the communication unit 826 may include one or more subunits as described herein for performing operations associated with providing relevant contextual features to the recipient during delivery of encrypted data.

In some embodiments, the server 810 may include a computing device such as a mainframe server, a content server, a communication server, a laptop computer, a desktop computer, a handheld computing device, a smart phone, a smart watch, a wearable device, a touch screen, a biometric device, a video processing device, an audio processing device, a cloud-based computing solution and/or service, and/or the like. In some embodiments, the server 810 may include a plurality of servers configured to communicate with one another and/or implement encryption techniques described herein.

In some embodiments, the server 810 may include various elements of a computing environment as described herein. For example, the server 810 may include a processing unit 828, a memory unit 830, an input/output (I/O) unit 832, and/or a communication unit 834. Each of the processing unit 828, the memory unit 830, the input/output (I/O) unit 832, and/or the communication unit 834 may include one or more subunits and/or other computing instances as described herein for performing operations associated with delivering encrypted data. In some embodiments, the memory unit 830 may not be present in the server 810.

The sender's device 804, the recipient's device 808, and/or the server 810 may be communicatively coupled to one another by a network 836 as described herein. In some embodiments, the network 836 may include a plurality of networks. In some embodiments, the network 836 may include any wireless and/or wired communications network that facilitates communication between the sender's device 804, the recipient's device 808, and/or the server 810. For example, the one or more networks may include an Ethernet network, a cellular network, a computer network, the Internet, a wireless fidelity (Wi-Fi) network, a light fidelity (Li-Fi) network, a Bluetooth network, a radio frequency identification (RFID) network, a near-field communication (NFC) network, a laser-based network, and/or the like.

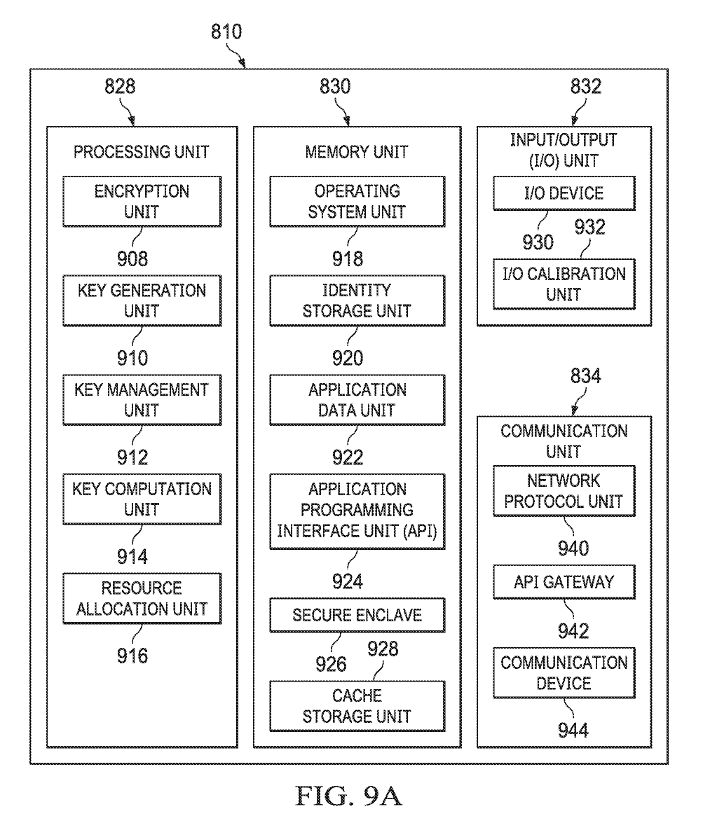

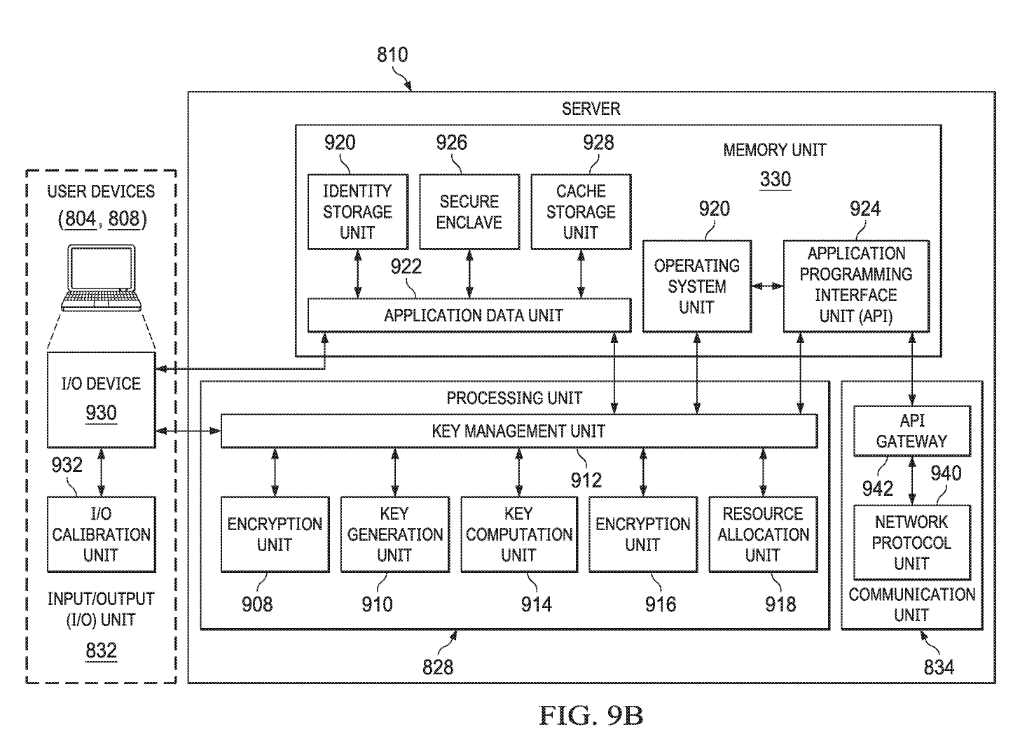

FIG. 9A and FIG. 9B illustrate exemplary functional and system diagrams for the server 810 for enabling delivery of encrypted data and associated encryption techniques described herein. Specifically, FIG. 9A provides a functional block diagram of the server 810, whereas FIG. 9B provides a detailed system diagram of the server 810. In addition, any units and/or submits described herein with reference to the server 810 of FIG. 9A and/or FIG. 9B may be included in one or more elements of FIG. 8 such as the sender (e.g., the processing unit 812, the optional memory unit 814, the I/O unit 816, and/or the communication unit 818), the recipient (e.g., the processing unit 820, the optional memory unit 822, the I/O unit 824, and/or the communication unit 826), and/or the server of FIG. 2, the key server of FIG. 3, and/or the server of FIG. 4-7 (e.g., the processing unit 828, the optional memory unit 830, the I/O unit 832, and/or the communication unit 834). However, the server 810 and the sender's device 804 may not be the same device, and the server 810 and the recipient's device 808 may not be the same device. The server 810 and/or any of its units and/or subunits described herein may include general hardware, specifically-purposed hardware, and/or software. Any of the units and/or sub-units illustrated and/or described herein are optional.

The server 810 may include, among other elements, a processing unit 828, an optional memory unit 830, an input/output (I/O) unit 832, and/or a communication unit 834. As described herein, each of the processing unit 828, the optional memory unit 830, the I/O unit 832, and/or the communication unit 834 may include and/or refer to a plurality of respected units, subunits, and/or elements. Furthermore, each of the processing unit 828, the memory unit 830, the I/O unit 832, and/or the communication unit 834 may be operatively and/or otherwise communicatively coupled with each other so as to facilitate the encryption and delivery technique described herein.

The processing unit 828 may control any of the one or more of the optional memory unit 830, the I/O unit 832, the communication unit 834, as well as any included subunits, elements, components, devices, and/or functions performed by the memory unit 830, the I/O unit 832, and the communication unit 834 included in the server 810. The described sub-elements of the server 810 may also be included in similar fashion in any of the other units and/or devices included in the system 800 of FIG. 8. Furthermore, any actions described herein as being performed by a processor may be taken by the processing unit 828 alone and/or by the processing unit 828 in conjunction with one or more additional processors, units, subunits, elements, components, devices, and/or the like. In addition, while only one processing unit 828 may be shown in FIG. 9A and/or FIG. 9B, multiple processing units may be present and/or otherwise included in the server 810 or elsewhere in the overall system (e.g. system 800 of FIG. 8). Thus, while instructions may be described as being executed by processing unit 828 (and/or various subunits of the processing unit 828), the instructions may be executed simultaneously, serially, and/or otherwise by one or multiple processing units.

In some embodiments, the processing unit 828 may be implemented as one or more computer processing unit (CPU) chips and may include a hardware device capable of executing computer instructions. The processing unit 828 may execute instructions, codes, computer programs, and/or scripts. The instructions, codes, computer programs, and/or scripts may be received from and/or stored in the optional memory unit 830, the I/O unit 832, the communication unit 834, subunits and/or elements of the aforementioned units, other devices and/or computing environments, and/or the like.

In some embodiments, the processing unit 828 may include, among other elements, subunits such as a key generation unit 910, a key management unit 912, a key computation unit 914, an encryption unit 908, and/or a resource allocation unit 916. Each of the aforementioned subunits of the processing unit 828 may be communicatively and/or operably coupled with each other.

The key generation unit 910 may facilitate generation, analysis, and/or presentation of cryptographic keys associated with a user. For example, the key generation unit 910 may generate a cryptographic key each time a user (e.g., the sender and/or the recipient) requests encryption of data. The key generation unit 910 may control and/or utilize an element of the I/O unit 832 to enable a user to request encryption and communicate progress of user requests.

The key management unit 912 may facilitate detection, analysis, transmission, and/or tracking of cryptographic keys. Cryptographic keys may include keys generated by the sender, keys generated by the recipients, keys generated by the key generation unit 910, and/or keys computed by the key computation unit 914. The key management unit 912 may receive cryptographic keys from users (e.g., the sender and the recipient), the key generation unit 910, and/or the key computation unit 914. The key management unit 912 may process, analyze, organize, and/or otherwise transfer any key received from users, the key generation unit 910, and/or the key computation unit 914. However, the key management unit 912 may not store cryptographic keys.

The key computation unit 914 may facilitate transformation of a cryptographic key. The key computation unit 914 may transform the representation of a cryptographic key using a mathematical function. A representation may include, but not be limited to, a mathematical value, a sequence of numbers and/or characters, a bit string, and any combination thereof. The key computation unit 914 may use inputs from users to transform a cryptographic key. Inputs from users may include an identity of a user, a private key of a user, a public key of a user, and /or the like. The key computation unit 914 may further use inputs from the key management unit 912 and/or the identity storage unit 920 to transform a cryptographic key. The key computation unit 914 may transmit transformed keys to the key management unit 912.

The encryption unit 908 may facilitate encrypting data using a cryptographic key. The encryption unit 908 may use cryptographic keys from the key generation unit 914, the key management unit 912, the key computation unit 914, and the keys transmitted from the users. The encryption unit 908 may perform a series of mathematical function to convert unencrypted data to encrypted form.

The resource allocation unit 916 may facilitate determination, monitoring, analysis, and/or allocation of computing resources throughout the server 810 and/or other computing environments. For example, the server 810 may facilitate a high volume of encryption and delivery of data between a large number of users. As such, computing resources of the server 810 utilized by the processing unit 828, the memory unit 830, the I/O unit 832, and/or the communication unit 834 (and/or any subunit of the aforementioned units) such as processing power, data storage space, network bandwidth, and/or the like may be in high demand at various times during operation. Accordingly, the resource allocation unit 916 may be configured to manage the allocation of various computing resources as they are required by particular units and/or subunits of the server 810 and/or other computing environments. In some embodiments, the resource allocation unit 824 may include sensors and/or other specially-purposed hardware for monitoring performance of each unit and/or subunit of the server 810, as well as hardware for responding to the computing resource needs of each unit and/or subunit. In some embodiments, the resource allocation unit 916 may utilize computing resources of a second computing environment separate and distinct from the server 810 to facilitate a desired operation.

For example, the resource allocation unit 916 may determine a number of simultaneous key generation/transformation/transfer and/or data encryption requests. The resource allocation unit 916 may then determine that the number of key generation/transformation/transfer and/or data encryption requests meets and/or exceeds a predetermined threshold value. Based on this determination, the resource allocation unit 916 may determine an amount of additional computing recourses (e.g., processing power, storage space of a particular non-transitory computer-readable memory medium, network bandwidth, and/or the like) required by the processing unit 828, the memory unit 830, the I/O unit 832, the communication unit 834, and/or any subunit of the aforementioned units for enabling safe and efficient operation of the server 810 while performing requested key generation/transformation/transfer and/or data encryption. The resource allocation unit 916 may then retrieve, transmit, control, allocate, and/or otherwise distribute determined amount(s) of computing resources to each element (e.g., unit and/or subunit) of the server 810 and/or other computing environment.

In some embodiments, factors affecting the allocation of computing resources by the resource allocation unit 916 may include the number of ongoing key generation/transformation/transfers and/or data encryptions, a duration of time during which computing resources are required by one or more elements of the server 810, and/or the like. In some embodiments, computing resources may be allocated to and/or distributed amongst a plurality of second computing environments included in the server 810 based on one or more factors mentioned above. In some embodiments, the allocation of computing resources of the resource allocation unit 916 may include the resource allocation unit 916 flipping a switch, adjusting processing power, adjusting memory size, partitioning a memory element, transmitting data, controlling one or more input and/or output devices, modifying various communication protocols, and/or the like.

In some embodiments, the optional memory unit 830 be utilized for storing, recalling, receiving, transmitting, and/or accessing various files and/or information during operation of the server 810. For example, the optional memory unit 830 may be utilized for storing user information, and the like. The optional memory unit 830 may include various types of data storage media such as solid state storage media, hard disk storage media, and/or the like. The optional memory unit 830 may include dedicated hardware elements such as hard drives and/or servers, as well as software elements such as cloud-based storage drives. For example, the optional memory unit 830 may include various subunits such as an operating system unit 918, an identity storage unit 910, an application data unit 922, an application programming interface (API) unit 924, a secure enclave 926, and/or a cache storage unit 928. In some embodiments, the optional memory unit 830 may not be present in server 810, yet the server can perform all the functions described herein.

The optional memory unit 830 and/or any of its subunits described herein may include random access memory (RAM), read only memory (ROM), and/or various forms of secondary storage. RAM may be used to store volatile data and/or to store instructions that may be executed by the processing unit 828. For example, the data stored may be a command, a current operating state of the server 810, an intended operating state of the server 810, and/or the like. As a further example, data stored in the memory unit 830 may include instructions related to various methods and/or functionalities described herein. ROM may be a non-volatile memory device that may have a smaller memory capacity than the memory capacity of a secondary storage. ROM may be used to store instructions and/or data that may be read during execution of computer instructions. In some embodiments, access to both RAM and ROM may be faster than access to secondary storage. Secondary storage may be comprised of one or more disk drives and/or tape drives and may be used for non-volatile storage of data or as an over-flow data storage device if RAM is not large enough to hold all working data. Secondary storage may be used to store programs that may be loaded into RAM when such programs are selected for execution. In some embodiments, the memory unit 830 may include one or more databases for storing any data described herein. Additionally or alternatively, one or more secondary databases located remotely from the server 810 may be utilized and/or accessed by the optional memory unit 830.

The operating system unit 918 may facilitate deployment, storage, access, execution, and/or utilization of an operating system utilized by the server 810 and/or any other computing environment described herein (e.g., a user device such as devices 804, 808 of FIG. 8). In some embodiments, the operating system may include various hardware and/or software elements that serve as a structural framework for enabling the processing unit 828 to execute various operations described herein. The operating system unit 918 may further store various pieces of information and/or data associated with operation of the operating system and/or the server 810 as a whole, such as a status of computing resources (e.g., processing power, memory availability, resource utilization, and/or the like), runtime information, modules to direct execution of operations described herein, user permissions, security credentials, and/or the like.

The identity storage unit 920 may facilitate deployment, storage, access, analysis, and/or utilization of user identities by the server 810 and/or any other computing environment described herein (e.g., a user device). A user identity may include, but not limited to, an email-address, or a phone number, or an Internet Protocol address, or a physical address of a computing device, or any representation that is operable to uniquely identify a recipient. For example, the identity storage unit 920 may store one or more user identities transmitted during a user registration. The identity storage unit 920 may transmit user identities to the key computation unit 914. In some embodiments, the identity storage unit 920 may not be present in the memory unit 830.

The application data unit 922 may facilitate deployment, storage, access, execution, and/or utilization of an application utilized by the server 810 and/or any other computing environment described herein (e.g., a device 804, 808). For example, users may be required to download, access, and/or otherwise utilize a software application on a user device such as a laptop in order for various operations described herein to be performed. As such, the application data unit 922 may store any information and/or data associated with the application. Information included in the application data unit 922 may enable a user to execute various operations described herein. The application data unit 922 may further store various pieces of information and/or data associated with operation of the application and/or the server 810 as a whole, such as a status of computing resources (e.g., processing power, memory availability, resource utilization, and/or the like), runtime information, modules to direct execution of operations described herein, user permissions, security credentials, and/or the like.

The API unit 924 may facilitate deployment, storage, access, execution, and/or utilization of information associated with APIs of the server 810 and/or any other computing environment described herein (e.g., a user device). For example, the server 810 may include one or more APIs for enabling various devices, applications, and/or computing environments to communicate with each other and/or utilize the same data. Accordingly, the API unit 924 may include API databases containing information that may be accessed and/or utilized by applications and/or operating systems of other devices and/or computing environments. In some embodiments, each API database may be associated with a customized physical circuit included in the memory unit 830 and/or the API unit 924. Additionally, each API database may be public and/or private, and so authentication credentials may be required to access information in an API database.

The secure enclave 926 may facilitate secure storage of data. In some embodiments, the secure enclave 926 may include a partitioned portion of storage media included in the memory unit 830 that is protected by various security measures. For example, the secure enclave 926 may be hardware secured. In other embodiments, the secure enclave 926 may include one or more firewalls, encryption mechanisms, and/or other security-based protocols. Authentication credentials of a user may be required prior to providing the user access to data stored within the secure enclave 926.

The cache storage unit 928 may facilitate short-term deployment, storage, access, analysis, and/or utilization of data. For example, the cache storage unit 928 may be utilized for temporarily storing a cryptographic key immediately before and/or after transfer/transformation. In some embodiments, the cache storage unit 928 may serve as a short-term storage location for data so that the data stored in the cache storage unit 928 may be accessed quickly. In some embodiments, the cache storage unit 928 may include RAM and/or other storage media types that enable quick recall of stored data. The cache storage unit 928 may include a partitioned portion of storage media included in the memory unit 830.

The I/O unit 832 may include hardware and/or software elements for enabling the server 810 to receive, transmit, and/or present information. In some embodiments, the term information may be used interchangeably with data or signals such as non-transitory signals. For example, elements of the I/O unit 832 may be used to receive user input from a user via a user device, present an encryption and/or decryption result to the user, and/or the like. In this manner, the I/O unit 832 may enable the server 810 to interface with a human user. As described herein, the I/O unit 832 may include subunits such as an I/O device 930 and/or an I/O calibration unit 932.

The I/O device 930 may facilitate the receipt, transmission, processing, presentation, display, input, and/or output of information as a result of executed processes described herein. In some embodiments, the I/O device 930 may include a plurality of I/O devices. In some embodiments, the I/O device 930 may include one or more elements of a user device, a computing system, a server, and/or a similar device.

The I/O device 930 may include a variety of elements that enable a user to interface with the server 810. For example, the I/O device 930 may include a keyboard, a touchscreen, a button, a sensor, a biometric scanner, a laser, a microphone, a camera, and/or another element for receiving and/or collecting input from a user. Additionally and/or alternatively, the I/O device 930 may include a display, a screen, a sensor, a vibration mechanism, a light emitting diode (LED), a speaker, a radio frequency identification (RFID) scanner, and/or another element for presenting and/or otherwise outputting data to a user. In some embodiments, the I/O device 930 may communicate with one or more elements of the processing unit 828 and/or the memory unit 830 to execute operations described herein.

The I/O calibration unit 932 may facilitate the calibration of the I/O device 432. For example, the I/O calibration unit 932 may detect and/or determine one or more settings of the I/O device 930, and then adjust and/or modify settings so that the I/O device 930 may operate more efficiently.

The communication unit 834 may facilitate establishment, maintenance, monitoring, and/or termination of communications between the server 810 and other devices such as users (e.g., user devices 804, 808 of FIG. 8), other computing environments, third party server systems, and/or the like. The communication unit 834 may further enable communication between various elements (e.g., units and/or subunits) of the server 810. In some embodiments, the communication unit 834 may include a network protocol unit 940, an API gateway 942, and/or a communication device 944. The communication unit 834 may include hardware and/or software elements.

The network protocol unit 940 may facilitate establishment, maintenance, and/or termination of a communication connection between the server 810 and another device (e.g., user devices 804, 808 of FIG. 8) by way of a network. For example, the network protocol unit 940 may detect and/or define a communication protocol required by a particular network and/or network type. Communication protocols utilized by the network protocol unit 940 may include Wi-Fi protocols, Li-Fi protocols, cellular data network protocols, Bluetooth® protocols, WiMAX protocols, Ethernet protocols, powerline communication (PLC) protocols, and/or the like. In some embodiments, facilitation of communication between the server 810 and any other device, as well as any element internal to the server 810, may include transforming and/or translating data from being compatible with a first communication protocol to being compatible with a second communication protocol. In some embodiments, the network protocol unit 940 may determine and/or monitor an amount of data traffic to consequently determine which particular network protocol is to be used for establishing connections with users to transfer keys and/or performing other operations described herein.

The API gateway 942 may facilitate the enablement of other devices and/or computing environments to access the API unit 924 of the optional memory unit 830 of the server 810. For example, a user device may access the API unit 924 via the API gateway 942. In some embodiments, the API gateway 942 may be required to validate user credentials associated with a user of a user device prior to providing access to the API unit 924 to the user. The API gateway 924 may include instructions for enabling the server 810 to communicate with another device.

The communication device 944 may include a variety of hardware and/or software specifically purposed to enable communication between the server 810 and another device, as well as communication between elements of the server 810. In some embodiments, the communication device 944 may include one or more radio transceivers, chips, analog front end (AFE) units, antennas, processing units, memory, other logic, and/or other components to implement communication protocols (wired or wireless) and related functionality for facilitating communication between the server 810 and any other device. Additionally and/or alternatively, the communication device 944 may include a modem, a modem bank, an Ethernet device such as a router or switch, a universal serial bus (USB) interface device, a serial interface, a token ring device, a fiber distributed data interface (FDDI) device, a wireless local area network (WLAN) device and/or device component, a radio transceiver device such as code division multiple access (CDMA) device, a global system for mobile communications (GSM) radio transceiver device, a universal mobile telecommunications system (UMTS) radio transceiver device, a long term evolution (LTE) radio transceiver device, a worldwide interoperability for microwave access (WiMAX) device, and/or another device used for communication purposes. While FIG. 9A is described as being the constituents of a server, in alternate embodiments, it could represent constituents of the device 804 or the device 808.

FIG. 9B illustrates an exemplary operation of the server 810. To begin operation of embodiments described herein, a sender (e.g., the sender 802 of FIG. 8) may download an encryption application associated with operations described herein, to a user device (e.g., the sender's device 804 of FIG. 8). For example, the user may download the encryption application from an application store or a library of applications available for download via an online network. In some embodiments, downloading the application may include transmitting application data from the application data unit 922 of the server 810 to the user device (e.g., the user device 804 of FIG. 8) via the communication unit 834.

Upon download and installation of the encryption application on the user device (e.g., the sender's device 804 of FIG. 8), the sender (e.g., the sender 802 of FIG. 8) may select and open the encryption application. The encryption application may then prompt the sender via the user device to register the sender and/or the device of the sender. In some embodiments, the sender may request to generate one or more new keys to register with the server 810. In some embodiments, the sender may send the request to the server 810, and the key generation unit 910 may generate new keys. In other embodiments, the processing unit (e.g., the processing unit 812 of FIG. 8) of user device (e.g., the user device 804 of FIG. 8) may generate new keys for the user and transmit the new keys to the key management unit 912. In some embodiments, the newly generated keys may include a new public key and a new private key for the sender. In some embodiments, the new private key may be transformed into a variant of the private key by a key deviation function using the processing unit (e.g., the processing unit 812 of FIG. 8) of the user device (e.g., the user device 804 of FIG. 8). The variant of the private key may be transmitted to the key management unit 912. In some embodiments, a variant of a private key may be referred to as a private key.

During the registration, the server may collect the sender's identities in the identity storage unit 920. An identity may include, but not limited to, an email-address, or a phone number, or an Internet Protocol address, or a physical address of a computing device, or any representation that is operable to uniquely identify a user. In some embodiments, the sender may enter the sender's user identities (e.g., e-mail address and/or phone number) using the I/O unit 816 from the user device. In some embodiments, the communication unit 944 may automatically read the user identities (e.g., physical address of the user device and/or Internet Protocol address) from the user device. Collected user identities may be stored in the identity storage unit 920.

After registration is complete, the sender may create data (e.g., a data file, a database object, a binary string, an e-mail, a text message, a document, a word file, a picture, an audio file, a video file, and any combination thereof) using the user device (e.g., the sender's device 804 of FIG. 8). After creating data, the user may be prompted by the encryption application to encrypt the data. The user may utilize an I/O device associated with an I/O unit 816 to request encryption of the data. In some embodiments, the user device may receive the request and generate a content key from the key generation unit of the processing unit of the user device. A content key may be a new cryptographic key that may be used to encrypt and decrypt data. A new content key may be generated for each set of data. The user device may encrypt one or more sets of data separately with the content keys using the encryption unit of the processing unit. The user device may further encrypt the content keys using the user's public key. Simultaneously, the user device may associate a tag to the encrypted content keys.

After encrypting the data, the server 810 may wait for a recipient (e.g., the recipient 806 of FIG. 8) to register. The recipient may download and install the encryption application and register with the server 810 in a similar manner the sender registers as described above. The recipient may register before, simultaneously, or after the sender registers. The recipient's identities may be stored in the identity storage unit 920.

After the recipient registers, the encrypted content key (e.g., the content key encrypted by the sender's public key) may be transmitted to the key management unit 912 and may be transferred to the key computation unit 914. The key generation unit 910 may generate a re-encryption key using at least one of the sender's private key, the recipient's identity, the tag attached to the encrypted content key, and the recipient's public key. The encrypted content key may be transformed to a transformation key in the key computation unit 914 using the re-encryption key. The transformation key may be transmitted from the key computation unit 914 to the key management unit 912. The key management unit 912 may further transmit the transformation key to the communication unit 834 to make the transformation key available to the recipient.

In some embodiments, the recipient's computing device (e.g., the recipient's device 808 of FIG. 8) may perform the decryption process after receiving the transformation key from the server 810. The recipient may receive the encrypted data and the transformation key by using the encryption application to read the encrypted data and the transformation key into the user device (e.g., the recipient's device 808 of FIG.8). The communication unit 816 may read the encrypted data and the transformation key into the user device (e.g., the recipient's device 808). The processing unit 820 may recover the content key from the transformation key using the recipient's private key. The processing unit 820 may further decrypt the data using the content key. The I/O unit 824 may display the decrypted data for the recipient.

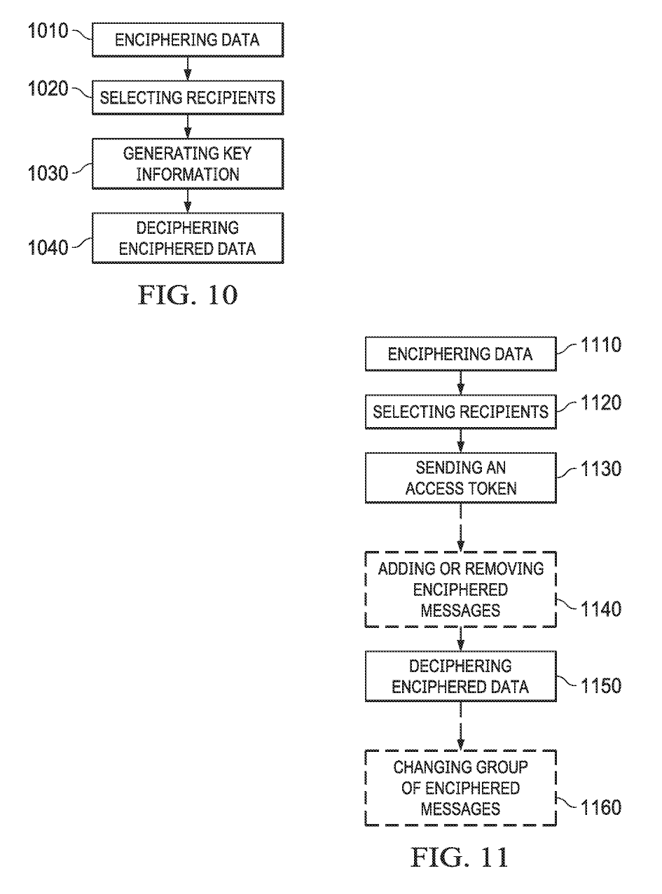

FIG. 10 provides a flow diagram illustrating a method for delivering enciphered data which may be enciphered prior to knowing a recipient according to a specific example embodiment of the disclosure.

When an initiating entity, which may be called a sender, delivers an enciphered data object to a receiving entity, which may be called a recipient, the current end-to-end encryption technology requires that: first, the recipient should already have a key generated and the sender should have a copy of the key of the recipient in advance; and second, the recipient's key should be known to the sender before the encryption can take place. However, these encryption systems may not work in instances where the recipient has not generated a key and the data has to be enciphered well before a recipient is known to the sender. Therefore, some embodiments of this disclosure are directed to a method for delivering encrypted data prior to knowing a recipient. In some embodiments, the sender may also be referred to as a data owner.

As shown in FIG. 10, in some embodiments, a method for delivering enciphered data may include an enciphering data process 1010. In some embodiments, a data owner may have a public key and a private key. In some embodiments, the data owner's public key may be used to encipher data. In some embodiments, the data owner's private key may be used to decipher enciphered data. According to some embodiments, an enciphering data process 1010 may include enciphering data with a data owner's public key. In some embodiments, a private key for deciphering data may be a data owner's private key. In other embodiments, a private key for deciphering data may be a recipient's private key. In some embodiments, the data owner may generate a symmetric key to encrypt data and encrypt the symmetric key with the data owner's public key. The enciphering data process 1010, in some embodiments, may not require prior knowledge of a recipient. Enciphering data without prior knowledge of a recipient may advantageously promote the ease of secure sharing by allowing the data owner to encrypt data at the data owner's convenience. Furthermore, enciphering data without prior knowledge of a recipient may advantageously promote efficient and secure use of resource and time by eliminating the need to wait for a recipient before encrypting data.

As shown in FIG. 10, the method for delivering enciphered data may include a choosing recipient process 1020. In some embodiments, the data owner may choose a recipient as the target recipient once the recipient has registered with a key server, which may be used to deliver keys to encrypt and decrypt data, and the recipient has generated a key. The data owner may have chosen a collection of recipients.

The key server may collect a unique identity of the recipient when the recipient registers with the key server. A unique identity may include one or multiple types of identification information. Identification information may include, but not limited to, an email address, a phone number, an Internet Protocol address, a physical or virtual address of a communication device, or any representations that can uniquely identify the recipient. Furthermore, in some embodiments, the recipient may generate a public key during registration of the recipient. The recipient may authenticate his or her legitimacy of possessing the unique identity before the key server would complete the registration. After registering with the key server, the recipient may readily decrypt the encrypted data. In some embodiments, the encrypted data may have been enciphered well before the recipient registers with the key server or the sender selects the recipient. According to some embodiments, a collection of recipients may be modified after the data has been enciphered and/or after the encrypted data has been delivered to the collection of recipients. Modifying a collection of recipients, in some embodiments, may not require a modification of enciphered data. In some embodiments, modifying a collection of recipient may not require re-encryption of the data.

In order to securely share data with the collection of recipients, in some embodiments, the data owner may send enciphered data to the collection of recipients directly. In other embodiment, the data owner may send enciphered data to a server, which acts as an intermediary between the sender and the recipient. In some embodiments, the server may be a cloud server. In some embodiments, the recipient may receive enciphered data, either directly from the sender or from the data server.

As shown in FIG. 10, according to some embodiments, a method for delivering enciphered data may include a generating key information process 1030. According to some embodiments, a generating key information process 1030 may include the data owner generating an access token. In some embodiments, an access token may be a key used to encipher another key or data. In some embodiments, an access token may be generated using at least one of the data owner's private key, the recipient's unique identity, and the recipient's public key. The access token may be transferred from the sender to the recipient through the key server or a trusted third party.

According to some embodiments, the data owner and/or the key server may not store any key and/or data. In some embodiments, the data owner and/or the key server may not use any memory to save keys used to encipher data. In some embodiments, no memory may be used to save recipient and tag specific information at the data owner's device (and/or the key server in some embodiments). In some embodiments, recipient and tag specific information may include a recipient's identity.

As shown in FIG. 10, according to some embodiments, a method for delivering enciphered data may include a deciphering enciphered data process 1040. In some embodiments, the deciphering enciphered data process 1040 may include the recipient deciphering data. According to some embodiments, during the deciphering enciphered data process 1040, the recipient may decipher the data using at least one of the access token and the recipient's private key.

According to some embodiments, enciphered data from an enciphering data process 1010 may only be deciphered by a data owner. In other embodiments, enciphered data from an enciphering data process 1010 may be deciphered only by the data owner and the collection of recipients authorized by the data owner.

FIG. 11 provides a flow diagram illustrating a method to manage bulk enciphered data sharing according to a specific example embodiment of the disclosure.

On the Internet or any form of computer networks or digital storage systems, data may need to be enciphered so that only the data owner and the intended receiving entities, which may be called recipients, specified by the data owner may retrieve the data from their enciphered form. In some embodiments, a huge amount of data may need to be enciphered and stored in a repository, which may include, but not limited to, a public cloud storage, a hard drive, a USB memory stick, a database, and/or any storage media and any combination thereof. Designating recipients who may access encrypted data may present challenges as the data owner may select recipients only after the data has been enciphered. In some embodiments of this disclosure, a data owner may encipher data using a symmetric key. In some embodiments, the symmetric key may then be further enciphered using a public key of the data owner. Re-encrypting the symmetric key with the public key may advantageously allow the data owner to be stateless in a manner that the data owner does not need to manage or memorize the symmetric keys used to encipher data. Re-encrypting the symmetric key with the public key may improve the security of data whereby each set of data can be encrypted with different symmetric key. Encrypting data with a symmetric key and re-encrypting the symmetric key may be also advantageously scalable because the amount of information (e.g., the information about the data owner's public key and private key) that the data owner requires to memorize may be constant and independent of the number of files or messages to be enciphered.

In some embodiments, new files and/or messages (i.e., new data) may be added even after sharing some data with the recipient. Furthermore, in some embodiments, new files and/or messages may be enciphered and delivered to the recipient even after the data owner has chosen recipients. In some embodiments, for files and/or messages shared with a recipient, the sender may need to generate an access token that is specific to the recipient. In some embodiments, the access token may have a fixed size regardless of how many files and/or messages that the data owner may share with the recipient. Furthermore, in some embodiments, the data owner may specify a subgroup of the enciphered files and/or messages to share with the recipient. In some embodiments, the data owner may change the formation of the subgroup of enciphered messages even after sharing with the recipient. In some embodiments, the number of access tokens to be given to a recipient may be constant and not linearly related to the number of files and/or messages.

In some embodiments, a symmetric key, which may be distinct from any existing key, may be used to encipher each message, and then a public key of the data owner may be used to encipher the symmetric key. In some embodiments, a tag may be used in encryption of data and/or any keys described herein. In some embodiments, a tag may be a binary string and may be arbitrarily chosen. A tag may be used to specify a subgroup of files and/or messages. In some embodiments, files and/or messages that the data owner selects to share with a recipient may have the same tag. In some embodiments, a tag may not be removed from the enciphered files and/or messages. In some embodiments, enciphered files and/or messages may not be deciphered by anyone when the tag associated with the files and/or messages is removed from the enciphered files and/or messages.

In some embodiments, only the data owner may decipher the enciphered data before an access token is given to a recipient. After the data owner has chosen a single recipient or a collection of recipients and a subgroup of files and/or messages to be shared with each recipient, the data owner may send to each recipient an access token that is specific to the recipient. In some embodiments, an access token may be a binary string with a constant size. In some embodiments, the size of an access token may be independent of the number of enciphered files and/or messages and enciphered symmetric keys that each recipient has access to. In some embodiments, the data owner may change a formation of a group of enciphered messages.

As shown in FIG. 11, in some embodiments, a method to manage bulk enciphered data sharing may include an enciphering data process 1110, which may transform a data set into an encrypted data set. In some embodiments, a data owner may have a public key, a private key, and a tag update key. A recipient may have a public key and a private key, wherein both the public key and the private key are different from the data owner's public key and private key. The data owner may select data (e.g., files and/or messages) to create a data set. In some embodiments, the enciphering data process 1110 may include the data owner generating symmetric keys to encrypt each data in the data set. The data owner may group the symmetric keys used to encrypt data in the data set into a set of symmetric keys. The enciphering data process 1110 may further include using the data owner's public key to transform the set of symmetric keys to an encrypted set of symmetric keys. In some embodiments, a tag may be attached to each symmetric key in the set of symmetric keys while transforming the set of symmetric keys to the encrypted set of symmetric keys. In some embodiments, a tag may be binary string. In some embodiments, a tag may be arbitrarily chosen. In some embodiments, a tag may be independent of other tags. In other embodiments, a tag may be dependent on each other. According to some embodiments, tags may be generated based on a functional mapping and related to other tags. The encrypted set of symmetric keys, in some embodiments, may be transformed back into the set of symmetric keys only by using the data owner's private key.

As shown in FIG. 11, in some embodiments, the method to manage bulk enciphered data sharing may include a selecting recipients process 1120. According to some embodiments, the selecting recipients process 1120 may include the data owner choosing a collection of recipients. A collection of recipients, in some embodiments, may include one or more recipients. According to some embodiments, a recipient may have a unique identity. In some embodiments, an identity may include, but is not limited to, an email address, a phone number, an Internet Protocol address, a physical or virtual address of a communication device, and any combination thereof.

As shown in FIG. 11, in some embodiments, the method to manage bulk enciphered data sharing may include a sending an access token process 1130. According to some embodiments, the sending an access token process 1130 may include the data owner generating an access token for a recipient. In some embodiments, an access token may comprise or be embedded with the tag chosen in the enciphering data process 1110. In some embodiments, the data owner may generate an access token using the data owner's private key, the recipient's public key, the recipient's identity, and the tag. In some embodiments, the tag may be used to check the data owner's authorization in securely sharing a data set. According to some embodiments, the data owner may further encrypt the encrypted set of symmetric keys to a re-encrypted set of symmetric keys using the access token. The re-encrypted set of symmetric keys may be deciphered back to original set of symmetric keys by the recipient's private key.

As shown in FIG. 11, in some embodiments, a method to manage bulk enciphered data sharing may include an optional adding or removing enciphered messages process 1140. According to some embodiments, the adding or removing enciphered messages process 1140 may include the data owner changing the tag associated with the data set shared with the recipient. The data owner may change the tag to a new tag, which may be called an update tag, using the data owner's tag update key. In some embodiments, the update tag may be an arbitrarily chosen binary string. In other embodiments, the update tag may be in formats other than a binary string format. In some embodiments, the data owner may change the tag attached to the encrypted data set to the update tag. In some embodiments, the data owner may generate a new encrypted set of symmetric keys, which may be called an updated encrypted set of symmetric keys, using the encrypted set of symmetric keys, the update tag, and the data owner's tag update key.

As shown in FIG. 11, in some embodiments, the method to manage bulk enciphered data sharing may include a deciphering enciphered data process 1150. According to some embodiments, the deciphering enciphered data process 1150 may include transforming the re-encrypted set of symmetric keys back to the encrypted set of symmetric keys. In some embodiments, the deciphering enciphered data process 1150 may include further transforming the encrypted data set back to the data set. In some embodiments, the deciphering enciphered data process may include transforming the re-encrypted set of symmetric keys back to the set of symmetric keys. In some embodiments, the re-encrypted set of symmetric keys may be transformed back into the set of symmetric keys by a recipient only when the tag associated in the re-encrypted set of symmetric keys is equal to the tag associated with the access token for the recipient.

During the deciphering enciphered data process 1150, in order to transform the re-encrypted set of symmetric keys, the recipient may use the access token given to the recipient. In some embodiments, the recipient may transform the re-encrypted symmetric keys to the set of symmetric keys with the recipient's private key when the access token is operable. According to some embodiments, only when each tag attached to each symmetric key in the re-encrypted set of symmetric keys is equal the tag associated with the access token, the access token may be operable. In some embodiments, when any of tags attached to the symmetric keys in the re-encrypted set of symmetric keys are not equal to the tag associated with the access token, the access token may not be operable. The recipient may use the access token to transform the re-encrypted set of symmetric keys to the set of symmetric keys.

As shown in FIG. 11, in some embodiments, a method to manage bulk enciphered data sharing may include an optional changing subgroup of enciphered messages process 1160. Similar to the adding or removing enciphered message process 1140, according to some embodiments, the changing subgroup of enciphered messages process 1160 may include the data owner changing the tag to another arbitrarily chosen tag, which may be called a modification tag. In some embodiments, a modification tag may be a binary string. In other embodiments, a modification tag may be in a format other than a binary string format. According to some embodiments, the data owner may update and make changes to the data set by adding and/or removing one or more data objects (e.g., files and/or messages) and modify the set of symmetric keys to the updated set of symmetric keys. The updated set of symmetric keys may be transformed to an updated encrypted set of symmetric keys using the data owner's tag update key and the modification tag. The updated encrypted set of symmetric keys may be transformed to the updated set of symmetric keys by using the data owner's private key. In some embodiments, the updated encrypted set of symmetric keys may be transformed to the updated set of symmetric keys with the access token given to the recipient when the modification tag is equal to the tag associated with the access token. In some embodiments, without a data owner's tag update key, no one may be able to update a tag associated with the data set. In some embodiments, the data owner may transform the encrypted set of symmetric keys to an update encrypted set of symmetric keys using the data owner's tag update key and the modification tag.

Some specific example embodiments of the disclosure are illustrated by one or more of the examples provided herein.

### EXAMPLE 1

### A Method To Make Bulk Enciphered Data Sharing

Given a data owner U, with a unique identifier IU, who has key information denoted by KeyU, a secret key information denoted by SKeyU, and a tag update key information denoted by TagKeyU. Given a collection of recipients {R1, R2, . . . , Rk} for some integer k, and each recipient has a unique identifier IRk. For each recipient, say Ri, the recipient has a key information denoted by KeyRi and a secret key information denoted by SKeyRi.

Given a collection of data denoted by {M1, M2, . . . , Mn} for some integer n. The data owner U ciphers the data collection into their ciphered data set denoted by {(C1, w1), (C2, w2), . . . , (Cn, wn)} using the following inputs and only the following inputs: the data collection {M1, M2, . . . , Mn}, U's key KeyU, n binary strings called tags {w1, w2, . . . , wn}. In the ciphering above, the n tags are arbitrarily chosen. They could be entirely independent to each other or dependent based on some functional mapping.

After ciphered data set {(C1, w1), (C2, w2), . . . , (Cn, wn)} is created, no one but the data owner can decipher the ciphered data set back to the data collection {M1, M2, . . . , Mn}. The deciphering can be done successfully only if the data owner U's secret key SKeyU and data owner's unique identifier IU are given.

To facilitate end-to-end secret exchange between data owner U and recipient Ri, a recipient-specific token RKi, associated with a tag (that is, an arbitrary length binary string) denoted by w, can be generated by the data owner U for a recipient Ri using the following inputs and only the following inputs: the data owner U's secret key SKeyU, the data owner's unique identifier IU, recipient unique identifier IRi, and the tag w.

The above recipient-specific token RKi can transform ciphered data (Cj, wj) from the ciphered data set {(C1, w1), (C2, w2), . . . , (Cn, wn)} to a new pair denoted by (Cj′, wj). Upon transformation, (Cj′, wj) remains as ciphered data in a different representation, and each representation may be unique to each recipient given the same data set. The transformation is done using the following inputs and only the following inputs: (Cj, wj) and RKi.

The new pair (Cj′, wj) can be deciphered back to the corresponding data Mj in the data collection {M1, M2, . . . , Mn} by the recipient Ri only if wj is equal to the tag w which is used during the generation of the recipient-specific token RKi. This transformation is done using the following inputs and only the following inputs: (Cj′ wj) and recipient Ri's secret key SKeyRi.

If all the tags in the transformed data set are equal, namely w1=w2= . . . =wn and they are equal to the tag w of the recipient-specific token RKi, then the single recipient-specific token RKi can transform all the pairs in the transformed data set {(C1, w1), (C2, w2), . . . , (Cn, wn)} to new pairs, and all the new pairs can be transformed back to the data collection {M1, M2, . . . , Mn} by recipient Ri using Ri's secret key SKeyRi.

Given a pair (Cj, wj) in the transformed data set {(C1, w1), (C2, w2), . . . ,(Cn, wn)}, the data owner U can change the tag wj to another arbitrarily chosen new tag (i.e., a binary string) w* and update the enciphered part Cj to a new enciphered part Cj* using the following inputs and only the following inputs: the enciphered part Cj, a new tag w*, and the data owner U's tag update key TagKeyU.

After a pair (Cj, wj) in the transformed data set {(C1, w1), (C2, w2), . . . ,(Cn, wn)} is updated to a new pair of enciphered part and new tag, respectively, (Cj*, w*), (Cj*, w*) can still be transformed back to Mj by the data owner U using secret key SKeyU.

After a pair (Cj, wj) in the transformed data set {(C1, w1), (C2, w2), . . . ,(Cn, wn)} is updated to a new pair of enciphered part and new tag, respectively, (Cj*, w*), (Cj*, w*) can still be transformed to a new pair denoted by (Cj*′, w*) using the recipient-specific token RKi. However, the new pair (Cj*′, w*) can only be transformed back to Mj by recipient Ri using the secret key SKeyRi only if w* is equal to the tag w which is associated with the recipient-specific token RKi.

Without the data owner U's tag update key TagKeyU, no one including the eligible recipients can update the tag of any pair in the transformed data set and still make the corresponding sharing then decryption work.

Any transmission, reception, connection, or communication described in this disclosure may occur using any short-range (e.g., Bluetooth, Bluetooth Low Energy, near field communication, Wi-Fi Direct, etc.) or long-range communication mechanism (e.g., Wi-Fi, cellular, etc.). Additionally or alternatively, any transmission, reception, connection, or communication may occur using wired technologies. Any transmission, reception, or communication may occur directly between systems or indirectly via one or more systems.

The term signal, signals, data, or information may refer to a single signal or multiple signals. Any reference to a signal may be a reference to an attribute of the signal, and any reference to a signal attribute may refer to a signal associated with the signal attribute. As used herein, the term “real-time” or “dynamically” in any context may refer to any of current, immediately after, simultaneously as, substantially simultaneously as, a few microseconds after, a few milliseconds after, a few seconds after, a few minutes after, a few hours after, a few days after, a period of time after, etc. In some embodiments, the term “modify” or “modification” may be interchangeably used with the term “transform” or “transformation.”

The present disclosure provides several important technical advantages that will be readily apparent to one skilled in the art from the figures, descriptions, and claims. Moreover, while specific advantages have been enumerated above, various embodiments may include all, some, or none of the enumerated advantages. Any sentence or statement in this disclosure may be associated with one or more embodiments. Reference numerals are provided in the specification for the first instance of an element that is numbered in the figures. In some embodiments, the reference numerals for the first instance of the element are also applicable to subsequent instances of the element in the specification even though reference numerals may not be provided for the subsequent instances of the element.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. A method for generating keys, comprising:
determining, at a sending computing device, a public key, the public key associated with the sending computing device or a user associated with the sending computing device;
accessing a collection of first keys, wherein each first key of the collection of first keys is mapped to each message in a sub-group of messages;
determining a first tag, the first tag identifying the sub-group of messages;
generating a collection of second keys based on the public key, the collection of first keys, and the first tag;
determining a receiving computing device for receiving the sub-group of messages;
generating a token based on recipient-specific information and tag-specific information, wherein the recipient-specific information comprises identification information associated with the receiving computing device, or a user associated with the receiving computing device, and the tag-specific information is associated with the first tag.

2. The method of claim 1, further comprising:
enciphering, at the sending computing device, messages, before the determining the receiving computing device;
selecting the sub-group of messages from enciphered messages; and
sending, from the sending computing device, the sub-group of messages.

3. The method of claim 1, further comprising:
re-generating the collection of first keys from the collection of second keys based on a secret key, the secret key known only to the sending computing device or a user associated with the sending computing device.

4. The method of claim 1, further comprising:
sending the collection of second keys and the token to a key server, wherein the key server, not the sending computing device, generates a collection of third keys based on the collection of second keys and the token; and
the key server, not the sending computing device, sends the collection of third keys to the receiving computing device, without access of a secret key known only to the sending computing device or a user associated with the sending computing device.

5. The method of claim 4, wherein the receiving computing device re-generates the collection of first keys from the collection of third keys based on a secret key, the secret key known only to the receiving computing device or a user associated with the receiving computing device.

6. The method of claim 4, wherein the collection of third keys cannot be sent to a third computing device or to a user unassociated with the sending computing device.

7. The method of claim 4, wherein the collection of first keys cannot be re-generated from the collection of third keys at a third computing device or by a user unassociated with the receiving computing device.

8. The method of claim 4, further comprising:
removing the token, wherein the receiving computing device cannot re-generate the collection of first keys from the collection of third keys.

9. The method of 2, further comprising:
enciphering new messages; and
adding enciphered new messages to the sub-group of messages.

10. The method of claim 2, further comprising:
determining a plurality of receiving computing devices;
generating a plurality of tokens;
generating a plurality of collections of third keys based on the tokens and the collection of second keys; and
sending the collections of third keys to the receiving computing devices.

11. The method of claim 10, wherein, for the sending of the sub-group of messages,
the collection of second keys is generated only once; and
only one token is generated for each receiving computing device.

12. The method of claim 10, wherein, the messages are enciphered only once prior to generating the plurality of tokens and sending the plurality of collections of third keys to the plurality of receiving computing devices.

13. The method of claim 1, wherein the sub-group of messages comprises a plurality of sub-groups of messages;
the collection of first keys comprises a plurality of collections of first keys;
the first tag comprises a plurality of first tags; and
the collection of second keys comprises a plurality of collections of second keys.

14. The method of claim 1, wherein each first key of the collection of first keys is used to encipher each message of the sub-group of messages.

15. The method of claim 10, wherein each first key of the collection of first keys is used to re-generate each message of the sub-group of messages.

16. The method of claim 1, wherein the identification information is selected from a group consisting of: an email address of the user associated with the receiving computing device, a phone number of the user associated with the receiving computing device, a social media address of the user associated with the receiving computing device, an Internet Protocol address of the receiving computing device, a physical address of the receiving computing device, a virtual address of the receiving computing device, and any combination thereof.

17. The method of claim 1, wherein the token is generated based on a secret key, the secret key known only to the sending computing device or a user associated with the sending computing device.

18. The method of claim 1, wherein the token is generated based on a receiving public key, the receiving public key associated with the receiving computing device.

19. A system for generating keys, the system comprising a computing device processor configured for:
determining, at a sending computing device, a public key, the public key associated with the sending computing device or a user associated with the sending computing device;
accessing a collection of first keys, wherein each first key of the collection of first keys is mapped to each message in a sub-group of messages;
determining a first tag, the first tag identifying the sub-group of messages;
generating a collection of second keys based on the public key, the collection of first keys, and the first tag;
determining a receiving computing device for receiving the sub-group of messages;
generating a token based on recipient-specific information and tag-specific information, wherein the recipient-specific information comprises identification information associated with the receiving computing device, or a user associated with the receiving computing device, and the tag-specific information is associated with the first tag.

20. A non-transitory computer-readable medium for generating keys, the non-transitory computer-readable medium comprising computer-executable code configured for:
determining, at a sending computing device, a public key, the public key associated with the sending computing device or a user associated with the sending computing device;
accessing a collection of first keys, wherein each first key of the collection of first keys is mapped to each message in a sub-group of messages;
determining a first tag, the first tag identifying the sub-group of messages;
generating a collection of second keys based on the public key, the collection of first keys, and the first tag;
determining a receiving computing device for receiving the sub-group of messages;
generating a token based on recipient-specific information and tag-specific information, wherein the recipient-specific information comprises identification information associated with the receiving computing device, or a user associated with the receiving computing device, and the tag-specific information is associated with the first tag.
